(19) United States
(12) Patent Application Publication
(10) Pub. No.: US 2016/0283483 A1
(43) Pub. Date: Sep. 29, 2016

(54) PROVIDING SELECTED IMAGES FROM A SET OF IMAGES

(71) Applicant: Google Inc., Mountain View, CA (US)

(72) Inventors: Ruirui JIANG, Sunnyvale, CA (US); Nicholas BUTKO, Cupertino, CA (US); Nan WANG, Mountain View, CA (US); Wingchi POON, Sunnyvale, CA (US); Jingyu CUI, Milpitas, CA (US); Gurshamnjot SINGH, Oakland, CA (US); Loren Frank PUCHALLA FIORE, Saratoga, CA (US); Shengyang DAI, Dublin, CA (US); Aravind KRISHNASWAMY, San Jose, CA (US); David LIEB, San Francisco, CA (US); Anil SABHARWAL, Los Altos, CA (US)

(73) Assignee: Google Inc., Mountain View, CA (US)

(21) Appl. No.: 15/081,858

(22) Filed: Mar. 26, 2016

Related U.S. Application Data
(60) Provisional application No. 62/139,573, filed on Mar. 27, 2015.

(51) Int. Cl. G06F 17/30; G06F 21/62

(52) U.S. Cl. CPC G06F 17/3053; G06F 17/30247; G06F 17/30554; G06F 21/6254; G06F 17/30327

(57) ABSTRACT

Implementations relate to providing selected images from a set of images. In some implementations, a computer-executed method includes receiving a request from a device for one or more images, where the request specifies one or more specified time periods at each of one or more specified time scales. One or more groups of selected images are determined from a set of images, each group being within one of the one or more specified time periods at one of the one or more specified time scales. One or more of the selected images from the one or more groups are caused to be sent to the device.

### CROSS-REFERENCE TO RELATED APPLICATIONS

The present application claims priority to U.S. Provisional Application No. 62/139,573, filed Mar. 27, 2015 and titled “Providing Selected Images from a Set of Images,” which is incorporated herein by reference in its entirety.

### BACKGROUND

The popularity and convenience of digital cameras as well as the widespread of use of Internet communications have caused user-produced images such as photographs to become ubiquitous. For example, many users keep large collections of digital images they have captured or obtained from various sources. Many users of Internet platforms and services such as email, bulletin boards, forums, social networking services, and other online/network services post images for themselves and others to see. Organizing and finding particular photos in large amounts of collected photos can pose a burden for many users.

### SUMMARY

Implementations of the present application relate to providing selected images from a set of images. In some implementations, a computer-executed method includes receiving a request from a device for one or more images, where the request specifies one or more specified time periods at each of one or more specified time scales. One or more groups of selected images are determined from a set of images, each group being within one of the one or more specified time periods at one of the one or more specified time scales. The method causes one or more of the selected images from the one or more groups to be sent to the device.

Various implementations and examples of the method are described. For example, The one or more specified time scales can be referenced in a stored hierarchical data structure storing a different time scale of images at each hierarchical level of the hierarchical data structure, where the different time scales of images are used for determining the one or more groups of selected images within the one or more specified time periods at the one or more specified time scales. In some examples, the groups of selected images can be organized in particular time periods defined in the hierarchical data structure based on time data associated with the images. For example, the one or more specified time scales can include an event level time scale, a day level time scale, a week level time scale, a month level time scale, a year level time scale, and/or a decade level time scale. In some examples, one or more specified time periods can include one or more particular dates of the calendar. Determining one or more groups of selected images can include examining the set of images and determining rankings of images in particular time periods based on image characteristics of the set of images, where the group of selected images can be determined from highest ranking images of the images in particular time periods. For example, each image can be associated with a time value, and determining rankings can be based on the image characteristics and based on providing a time diversity for the time values of successively-ranked images.

Causing the one or more selected images to be sent can include sending one or more image identifiers that identify the one or more selected images. The method can further include determining the one or more selected images to be sent to the requesting device based on one or more characteristics of the one or more selected images, where the one or more characteristics can include a number of images included in the respective selected groups of the one or more selected images, a time distribution of images included in the respective selected groups of the one or more selected images, and/or a type of content depicted in the one or more selected images.

In some implementations, a computer readable medium can have stored thereon software instructions that, when executed by a processor, cause the processor to perform operations. The operations include receiving, at a client device from a server, image identification structured data including groups of selected image identifiers selected from one or more sets of images. The groups of selected image identifiers are organized in a hierarchical data structure storing a different time scale of images at each hierarchical level of the hierarchical data structure. The image identification structured data is examined by the client device to obtain a number of selected images from one or more of the groups of selected images at a specified time scale. The operations request a number of images corresponding to the number of selected image identifiers from a server, receive the number of images from the server, and display the number of images on a display of the client device.

In various implementations of the computer readable medium, the hierarchical data structure can include a plurality of defined time periods at each of the different time scales, where the groups of selected images are provided in particular time periods defined in the hierarchical data structure based on time data associated with the images. The selected image identifiers in the groups can be determined based on one or more image characteristics of images corresponding to the one or more sets of image identifiers, where the selected image identifiers correspond to images having a particular ranking among images associated with time periods associated with the groups. The selected images in each of the groups can be associated with times that are diverse over time periods associated with the groups. One or more of the selected image identifiers can be included in multiple groups of selected images at different hierarchical levels of the hierarchical data structure. The operations can further comprise requesting an update to the image identification structured data; receiving updated image identification structured data; and updating the groups of selected image identifiers in the hierarchical data structure.

In some implementations, a system includes a storage device; and at least one processor accessing the storage device and configured to perform operations including storing image identifiers for a set of images at a first hierarchical level of a data structure representing a first time scale. The operations determine a ranking order of a plurality of the image identifiers based on one or more characteristics of the images in the set of images corresponding to the plurality of image identifiers. The operations store, at a second hierarchical level of the data structure, one or more highest ranking image identifiers in a group of selected image identifiers, where the second hierarchical level represents a second time scale at a higher time granularity. The operations send at least one image identifier of the group of selected image identifiers to a requesting device.

Various implementations and examples of the system are described. For example, the data structure can include a plurality of defined time periods at each of the hierarchical levels, where the group of selected image identifiers is provided in a particular time period defined in the data structure based on time data associated with the images. The defined time periods include different event time periods at an event level, different day time periods at a day level, different week time periods at a week level, and/or different month time periods at a month level of the hierarchical data structure. The operations can further include providing one or more additional hierarchical levels of the data structure, where each additional hierarchical level stores one or more groups of highest ranking image identifiers derived from one or more groups of highest ranking image identifiers at the next lower level of the data structure. The set of images can be one of a plurality of sets of images, each set of images covering a different time period in a timeline, and for each of the sets of images at each different time period, determining a ranking order and storing one or more highest ranking identifiers can be repeated.

The group of selected image identifiers can be sent to the requesting device at a synchronization time, and the operations can further include receiving one or more updates to the set of images, determining an updated ranking order of the plurality of the image identifiers, storing, at the second hierarchical level of the data structure, one or more highest ranking image identifiers in the group of selected image identifiers, where the group is based on the updated ranking order, and sending one or more image identifiers from the updated group of selected image identifiers to the requesting device in response to receiving a second request from the device that indicates the synchronization time.

Determining a ranking order can include assigning the plurality of image identifiers to nodes in a ranking data structure, where the plurality of image identifiers are assigned in a time order based on a time associated with each image identifier, and each of the plurality of image identifiers is associated with an image characteristic score based on one or more characteristics of an image identified by the image identifier; and determining a ranking order of the plurality of image identifiers based on the scores and based on a time diversity of time values of the plurality of the image identifiers, where the ranking data structure is used to provide the time diversity for successively-ranked image identifiers. In some examples, the ranking data structure can be a binary tree structure and the nodes can be leaf nodes in the binary tree structure, and each successive image in the ranking order can be selected from an unused branch of the binary tree and have the next highest image characteristic score among the images in the unused branch. Assigning the plurality of image identifiers to nodes can include assigning one image identifier to a node from a similarity group of image identifiers determined to refer to visually similar images.

### BRIEF DESCRIPTION OF THE DRAWINGS

FIG. 1 is a block diagram of an example network environment which may be used for one or more implementations described herein;

FIG. 2 is a flow diagram illustrating an example method to provide selected images from a set of images, according to some implementations;

FIG. 3 is a flow diagram illustrating another example method to determine selected images for a device, according to some implementations;

FIG. 4 is a flow diagram illustrating an example method to provide a data structure that stores image identifiers at multiple time scales, according to some implementations;

FIGS. 5A and 5B are diagrammatic illustrations of examples of hierarchical data structures that can be used with one or more features described herein, according to some implementations;

FIG. 6 is a flow diagram illustrating an example method to provide a ranking data structure that enables ranking of images based on one or more image characteristics, according to some implementations;

FIG. 7 is a diagrammatic illustration of one example of a tree structure that can be used to determine a ranking order of a plurality of images and image identifiers, according to some implementations;

FIGS. 8A and 8B are diagrammatic illustrations of an example user interface displayed on a display of a device and illustrating one or more features described herein, according to some implementations;

FIG. 9 is a flow diagram illustrating an example method to notify and display past images for a user, according to some implementations;

FIGS. 10A-10C are diagrammatic illustrations of example notifications and other features allowing a user to view images based on notifications received by the user, according to some implementations;

FIG. 11 is a block diagram of an example device which may be used for one or more implementations described herein.

### DETAILED DESCRIPTION

One or more implementations described herein relate to providing selected images from a set of images. In some implementations, a system receives a request from a device for one or more images at one or more specified time scales. The system determines one or more groups of selected images from a set of images, where each group is at one of the specified time scales. One or more of the selected images from the groups is sent to the device. Described features allow devices to request images from a set of images at various desired time scales.

Some implementations allow a device, e.g., a client device, to receive image identification structured data including groups of selected image identifiers selected from sets of images. The groups of selected image identifiers can be organized in a hierarchical data structure storing a different time scale of images at each level of the hierarchical data structure. The device can examine the image identification structured data to obtain a specific number of selected images from one or more of the groups of selected images at a specified time scale. The device can request the specific number of selected images from a server. Features allow a device to locally find selected images at desired time scales using structured data. This may permit flexibility in the display and other processing of images by the device.

Some implementations can provide a hierarchical data structure enabling retrieval of selected images at desired time scales. A system can store image identifiers for a set of images at a first hierarchical level of a data structure representing a first time scale. A ranking order of the image identifiers is determined based on one or more characteristics of the images in the set of images. The system stores one or more highest ranking image identifiers in a group of selected image identifiers at a second hierarchical level of the data structure that represents a second time scale at a higher time granularity. The system can, for example, send the image identifiers for the set of images and the group of selected image identifiers to a requesting device. The data structure can enable determination of and access to selected sets of ranked images at different time scales quickly and efficiently.

Some implementations can provide a ranking data structure for ranking images. A system can assign image identifiers to nodes in the ranking data structure in a time order. Each image identifier is associated with a score based on one or more characteristics of an image identified by the image identifier. The system can determine a ranking order of the image identifiers using the ranking data structure to provide time diversity in the time values (e.g., time of capture) for successively-ranked images. The system can store ranked image identifiers in a group of selected image identifiers, based on the ranking order. Ranked image identifiers can be provided to a requesting device, for example. For example, the ranking data structure can provide ranked images that also include time diversity.

Some implementations can select images from sets of images that are to be provided in notifications to users. For example, the selected images can be relevant and significant images to a user from the user's collections, and can be selected at particular time ranges and/or scales, e.g., at particular times in the past relative to a notification date. For example, images from yearly (or other) intervals prior to the notification date can be selected to be provided in a notification to the user. The images can also be selected based on various image characteristics including the number and time distribution of images captured at events, the types of content depicted in the images (if user consent is obtained), repeating characteristics of the images over particular time intervals, etc.

Features described herein allow high-ranking, quality images to be found from a set of images. For example, the hierarchical data structure can allow a system to determine a group of selected images at a higher level (e.g., larger) time scale based on groups of images from a lower level (e.g., smaller) time scale in the data structure. This can provide processing savings since a smaller number of images can be examined and ranked. The use of a ranking data structure can provide greater time diversity in ranked images selected from a set of images, thus providing images for users that may have more content variety. The hierarchical data structure provides efficient determination of high-ranking selected images at desired time scales. This may allow a device with relatively low computational resources to efficiently find and/or rank images for display and other processing without significant time and processing requirements. The hierarchical data structure can organize a set of images over various time ranges and based on events determined from the images, and images can be accessed based on any requested time period. Maintenance and updates to the hierarchical data structure can be efficiently performed for affected groups of the hierarchy and such updates can be incrementally sent to synchronizing devices. Various features allow very large collections of images to be examined and the highest quality and most interesting images made readily available for display to the user at various display time scales and other requested parameters. Notification of users with relevant and significant images from their collections can be performed automatically and at relevant times. Consequently, a technical effect of one or more described implementations is that search, organization, access, and presentation of images is reduced in computational time and resources expended to obtain results.

The systems and methods discussed herein do not require collection or usage of user personal information. In situations in which certain implementations discussed herein may collect or use personal information about users (e.g., user data, information about a user's social network, user's location, user's biometric information, user's activities and demographic information), users are provided with one or more opportunities to control whether information is collected, whether the personal information is stored, whether the personal information is used, and how the information is collected about the user, stored and used. That is, the systems and methods discussed herein collect, store and/or use user personal information only upon receiving explicit authorization from the relevant users to do so. For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user's geographic location may be generalized to a larger region so that the user's particular location cannot be determined.

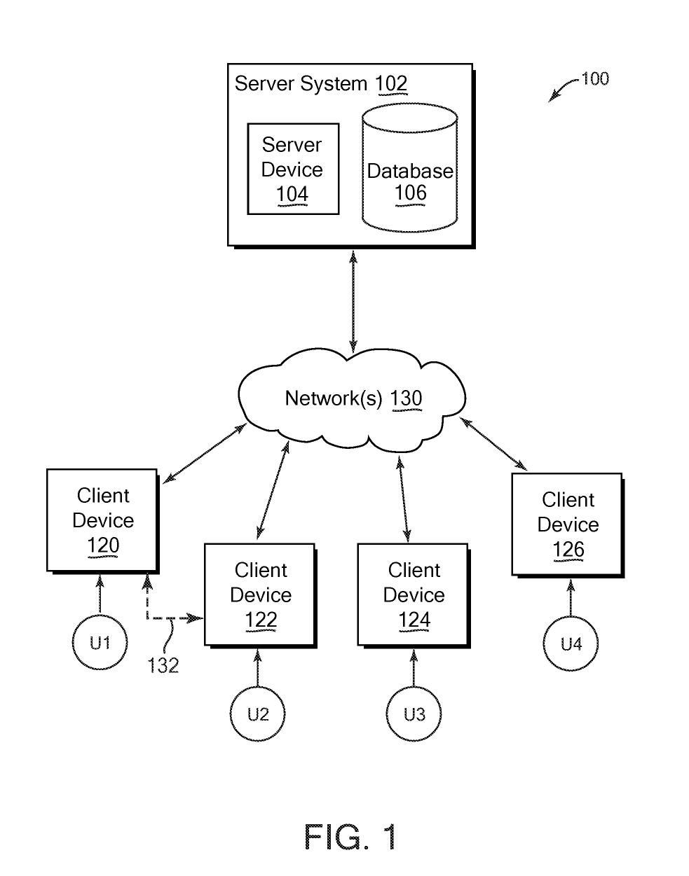

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104 and a database 106 or other storage device. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Server blocks 102, 104, and 106 may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., a desktop computer, laptop computer, portable or mobile device, cell phone, smart phone, tablet computer, television, TV set top box or entertainment device, wearable devices (e.g., display glasses or goggles, wristwatch, headset, armband, jewelry, etc.), personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some example implementations, users U1, U2, U3, and U4 may interact with each other via applications running on respective client devices and/or server system 102, and/or via a network service, e.g., a social network service or other type of network service implemented on server system 102. For example, respective client devices 120, 122, 124, and 126 may communicate data to and from one or more server systems (e.g., system 102). In some implementations, server system 102 may provide appropriate data to the client devices such that each client device can receive communicated content or shared content uploaded to the server system 102 and/or network service. In some examples, the network service can include any system allowing users to perform a variety of communications, form links and associations, upload and post shared content such as images, video, audio, and other types of content, and/or perform other socially-related functions. For example, the network service can allow a user to send messages to particular or multiple other users, form social links in the form of associations to other users within the network service, group other users in user lists, friends lists, or other user groups, post or send content including text, images, video sequences, audio sequences or recordings, or other types of content for access by designated sets of users of the network service, participate in live video, audio, and/or text chat with other users of the service, etc. In some implementations, a “user” can include one or more programs or virtual entities, as well as persons that interface with the system or network.

A user interface can enable display of images, video data, and other content as well as communications, privacy settings, notifications, and other data on a client device 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, such as a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide an image display application. The image display application may allow a user to edit and/or display various images. The image display application can provide an associated user interface that is displayed on a display device associated with the server system or client device. The user interface may provide various display functions (e.g., display modes) for designated images and other functions.

Other implementations of features described herein can use any type of system and/or service. For example, photo collection services or other networked services (e.g., connected to the Internet) can be used instead of or in addition to a social networking service. Any type of electronic device can make use of features described herein. Some implementations can provide features described herein on client or server devices disconnected from or intermittently connected to computer networks. In some examples, a client device including or connected to a display device can examine and display images stored on storage devices local to the client device (e.g., not connected via a communication network) and can provide features and results as described herein that are viewable to a user.

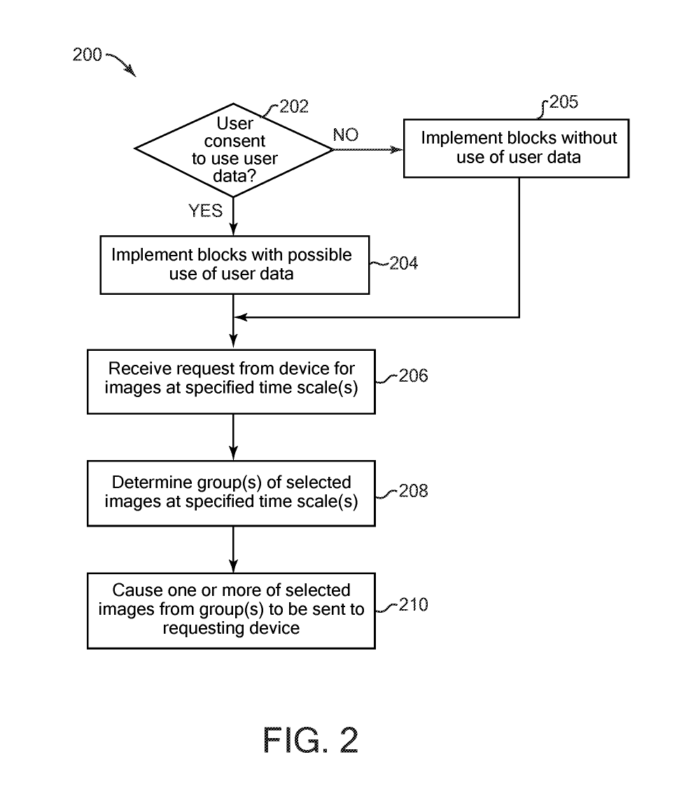

FIG. 2 is a flow diagram illustrating one example of a method 200 to provide selected images from a set of images. In some implementations, method 200 can be implemented, for example, on a server system 102 as shown in FIG. 1. In other implementations, some or all of the method 200 can be implemented on a system such as one or more client devices 120, 122, 124, or 126 as shown in FIG. 1, and/or on both a server system and a client system. In described examples, the implementing system includes one or more processors or processing circuitry, and one or more storage devices such as a database 106 or other storage. In some implementations, different components of one or more servers and/or clients can perform different blocks or other parts of the method 200.

An image as described herein can be a digital image composed of multiple pixels, for example. An image as described herein can be stored on one or more storage devices of the implementing system or otherwise accessible to the system, such as a connected storage device, e.g., a local storage device and/or storage device connected over a network. In various implementations, images can be obtained from a variety of sources, e.g., uploaded by a user to a server over one or more networks, obtained from an album or other stored collection of multiple images owned or accessible by a user, etc. An image identifier can be any reference or pointer to an associated stored image. Examining or selecting an image identifier may, for example, allow retrieval of the associated image. In features and implementations described herein, image identifiers can be stored in described data structures. In one or more of these features and implementations, the referenced images (e.g., image pixel data) can be stored in the data structures, instead of or in addition to the image identifiers.

In block 202, it is checked whether user consent (e.g., user permission) has been obtained to use user data in the implementation of method 200. For example, user data can include user preferences, user biometric information, user characteristics (identity, name, age, gender, profession, etc.), information about a user's social network and contacts, social and other types of actions and activities, content, ratings, and opinions created or submitted by a user, a user's current location, historical user data, etc. One or more blocks of the methods described herein may use such user data in some implementations. If user consent has been obtained from the relevant users for which user data may be used in the method 200, then in block 204, it is determined that the blocks of the methods herein can be implemented with possible use of user data as described for those blocks, and the method continues to block 206. If user consent has not been obtained, it is determined in block 205 that blocks are to be implemented without use of user data, and the method continues to block 206. In some implementations, if user consent has not been obtained, the remainder of method 200 is not performed.

In block 206, a request is received from a device for one or more images at one or more specified time scales. For example, a server (or client device) can receive the request from a client device over a network or other communication medium. In some implementations, the requested images can be from a set of images that are associated with the requesting device, e.g., a collection of images associated with a user operating the requesting device, known via an account logged in by the user of the device, a client identification or user identification sent with the request, or other provided information from the client device obtained previously or concurrently with the request. In some implementations, the request can specify a number of images that are requested, e.g., in total, at each of one or more specified time scales, etc.

In some implementations, each specified time scale can be a particular time scale of a hierarchy of time scales. For example, the requesting device may be able to specify one or more of the time scales in the hierarchy of time scales. In some examples, available time scales in the hierarchy can include an event level time scale, a day level time scale, a week level time scale, a month level time scale, a year level time scale, a decade level time scale, a lifetime level time scale, etc., and/or other time scales. Each time scale provides a level of detail (e.g., a number of images) over the time length indicated. For example, a week time scale may provide a requested number of images over a week, while a month time scale may provide that requested number of images over a month. The specified time scale(s) can be provided as information in or alongside the request, or may have been specified differently, e.g., as determined from accessed preferences for the requesting device or user of the requesting device, and/or based on current user conditions or states (e.g., determined from user data such as current location of user (e.g., requesting device) based on sensed location, current mood/emotion of user based on analysis of current images captured depicting user, etc.). In some implementations, a time scale can be inferred by the system based on a request that specifies images depicting particular types of content. For example, a request that specifies images related to an event recurring within a particular time period (e.g., an annual event) can cause the method to specify an appropriate time scale to find such events (e.g., a year time scale, decade time scale, or higher time scale for the annual event).

In some implementations, the device request also specifies (or is associated with) one or more time periods at each of the specified time scales. In some examples, the device request can specify that a specific number of images are requested for the time period of January to February of the current year, at the month level time scale. In some implementations, a time period can be specified based on times (e.g., 1 pm to 9 pm of specified days), days or dates of the calendar (March 16 to Mar. 27, 2005), months (March to May 2005), years (1995 to 2005), or in other ranges. In various implementations, multiple time periods specified in the request may be overlapping or non-overlapping (e.g., a particular time period at a week time scale may occur within another specified time period at a month time scale or year time scale). In some implementations, a resulting time period can be determined that is the intersection of two or more specified time periods, and the resulting time period can be used as the specified time period. An image can be associated with a time (e.g., a timestamp stored with the image as metadata indicating time of capture or other time associated with the image). An image can be placed in particular sets and/or groups having defined time ranges (time periods) based on the image's associated time(s). In some implementations, an image can have multiple associated times (e.g., time values). For example, the associated times can include date captured, date edited, user-specified date, shared date (e.g., shared, transmitted, or otherwise made accessible to other users on a network service), etc. Different implementations can use a particular time associated with images.

In block 208, one or more groups of selected images are determined at the specified time scale(s). (In some cases, the selected images may be referred to herein as “featured images.”) In some implementations, a hierarchical time scale data structure can be used in determining the group of selected images. The hierarchical time scale data structure can be a data structure storing image identifiers of images (e.g., references to images), where the images are accessible to the requesting device or a user associated with the requesting device. Each hierarchical level can represent a different time scale. In some implementations, the images referenced by the hierarchical data structure can be images captured and otherwise obtained by a particular user over time, e.g., a user associated with the requesting device. Some implementations can store image identifiers in other types or forms of data structures or memory locations. To determine a group of selected images, a group of selected image identifiers from the data structure can be determined.

In some implementations, to determine a group of selected images for a specified time scale, one or more image identifiers can be selected from one or more sets of image identifiers identified at a lower time scale level below the specified time scale. The lower time scale level can be a more detailed time scale (e.g., at a higher level of time granularity) than the specified time scale. This lower time scale level can correspond with a lower level in the hierarchical time scale data structure. For example, if the specified time scale is the week level, image identifiers stored at the lower, day level of the hierarchical data structure can be examined and the group of selected image identifiers can be determined from those image identifiers.

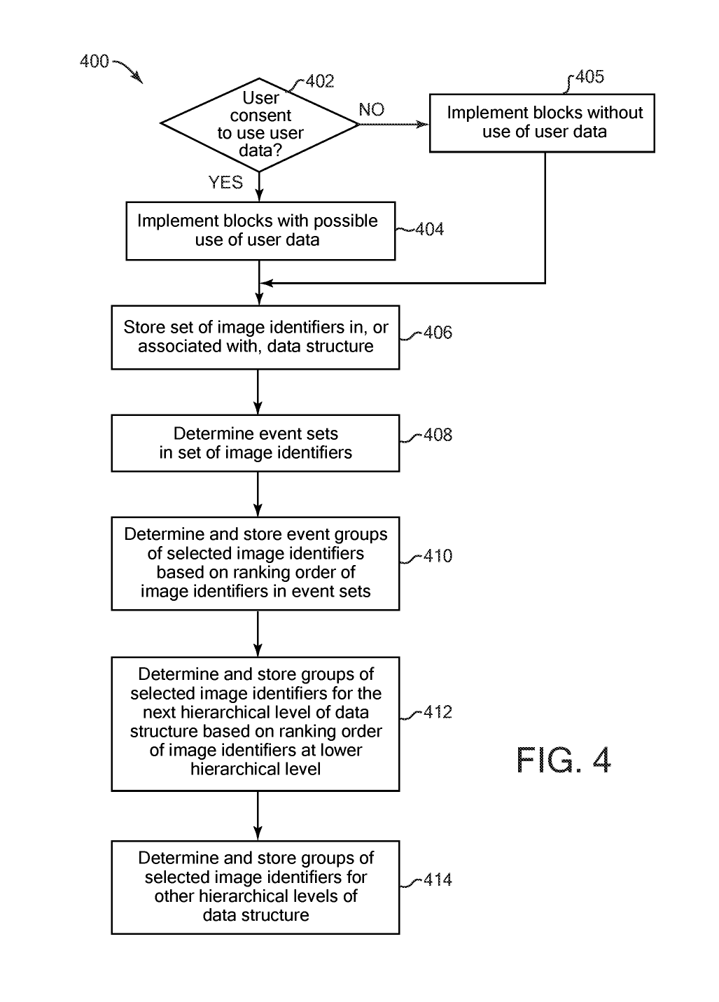

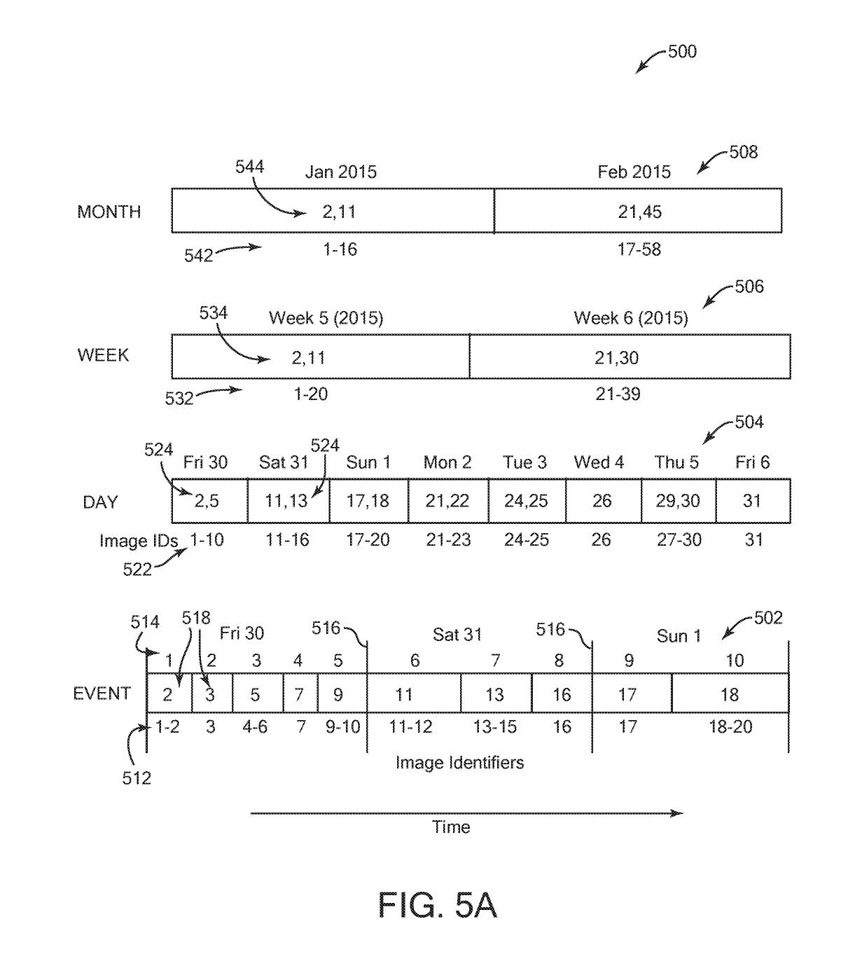

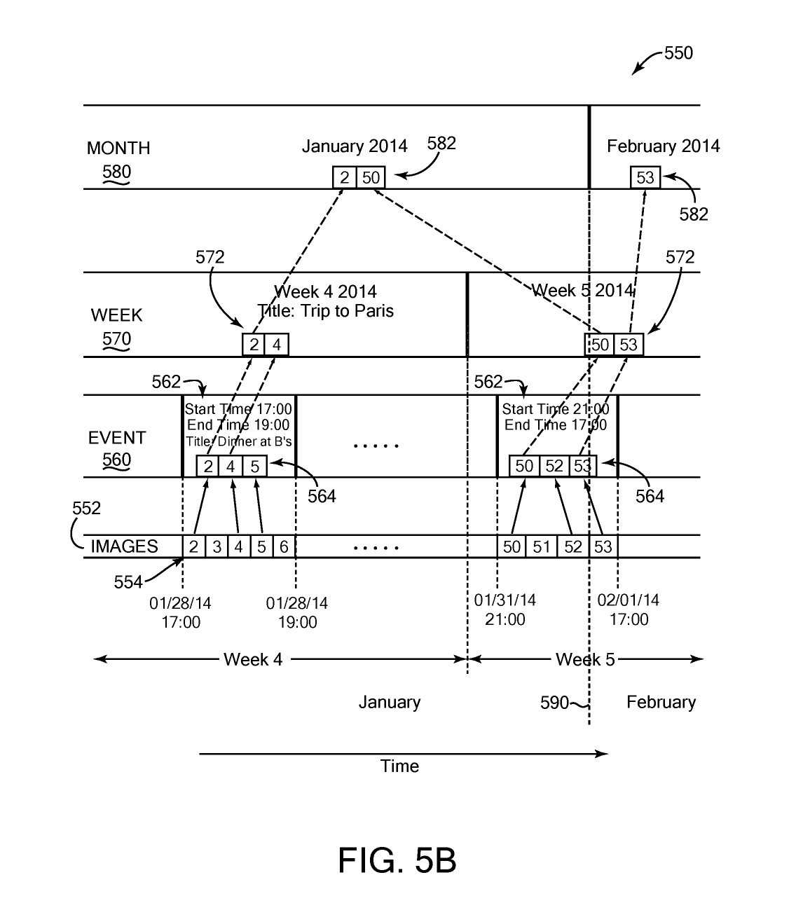

In some implementations, a group of selected image identifiers can be determined based on one or more groups of selected image identifiers stored at the next lower level of the hierarchical data structure. For example, the group of selected image identifiers can include image identifiers from the lower level groups. In some example data structures, initial groups can be determined as events based on time intervals or other factors, as described in examples herein. In some implementations or cases, an implementing system may determine groups of selected images at the lowest level image identifiers available, derive groups of selected images at the next higher level from those groups, and so on, until groups at the specified or desired time scale level have been determined. For example, in some implementations, if lower level groups of selected image identifiers were not previously determined, they can be determined as needed for higher groups of selected image identifiers. Some examples of a hierarchical data structure are described below with reference to FIGS. 4 and 5.

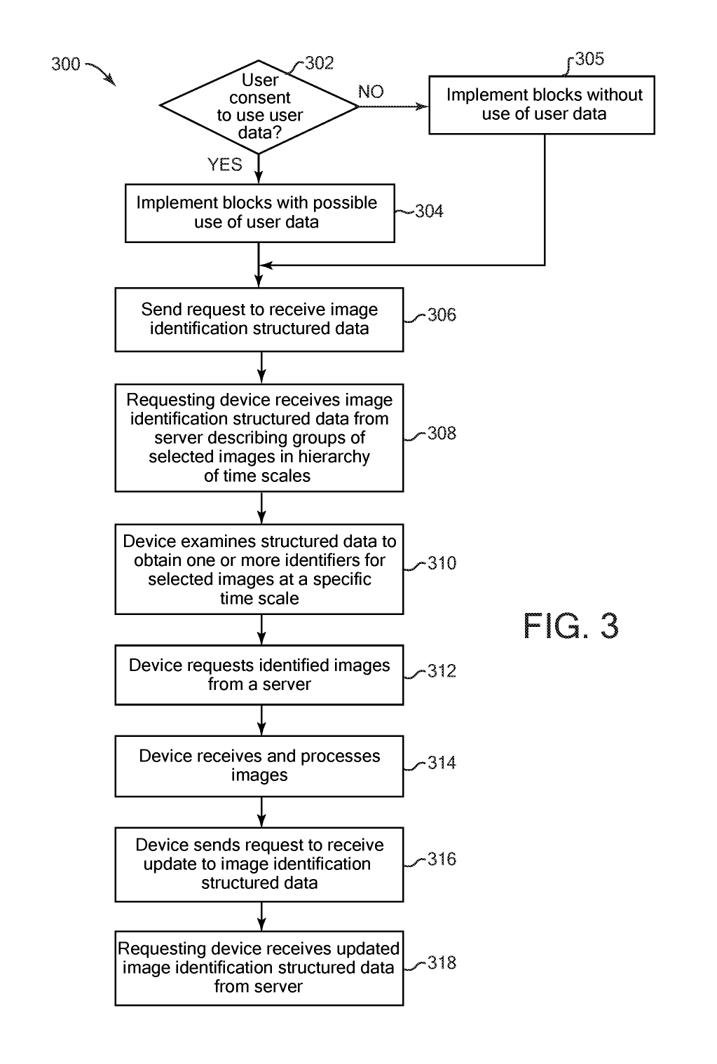

To determine a group of selected image identifiers, several image characteristic factors can be examined that indicate particular image characteristics of the images from which the group is selected. In some implementations, such factors may be used to increase or decrease a weight or score of a particular image, and adjust its rank relative to other images having different factors (e.g., different types and/or magnitudes of factors). A ranking of the images can be determined based on such factors, such that the highest ranking images are selected for the group. Some examples of determining a group of selected images using a hierarchical time scale data structure and ranking images based on one or more image characteristic factors are described below with reference to FIGS. 3-8.

In block 210, one or more of the selected images from the determined group is caused to be sent to the requesting device, e.g., over a network or other communication medium. For example, in some implementations, these sent images are the images referenced by the image identifiers from the groups determined in block 208. In some example implementations, the request from the device may be a request for a specific number of images. That number of images from the group(s) of selected images is sent to the client device. In some implementations, the implementing system can send, or can instruct that a server (or other device) send, the selected images (e.g., image data) that are identified by the image identifiers in the group(s) to the requesting device. In some implementations, the implementing system can send the requested image identifiers to the requesting device, and the requesting device can request the images, e.g., from a server that in turn sends the images to the device. Some examples of a device using image identifiers to request images is described in greater detail below with respect to FIG. 3.

In some implementations, method 200 performs the determining of the group of selected images in a requested timescale in response to receiving a device request and device-specified time scales, as described above. In some implementations, the method can determine one or more groups of selected images (and/or image identifiers) before any device requests, e.g., as pre-processing. This can allow the method to respond to a device request faster by retrieving pre-processed stored groups of selected image identifiers from the data structure at one or more time scales requested by the device and sending the image identifiers and/or corresponding images to the requesting device. In some implementations, if multiple requests are received from the same user or user device to provide images from the same time scale and same time period, the method can determine different sets of images for each request to provide diversity of images to the requestor. For example, images further down the ranked list for that time period and different from previous set(s) of sent images can be provided to the requesting device in response to a successive request, and/or additional available images can be ranked and provided to the requesting device in response to the successive request.

FIG. 3 is a flow diagram illustrating an example method 300 to determine selected images for a device. In the example of method 300, a device retrieves data describing multiple time scales of images from a different device, and uses the data to select particular images at desired time scales.

In some implementations, method 300 can be implemented on a client device, e.g., any of client devices 120-126 as shown in FIG. 1. In some examples, a camera, cell phone, tablet computer, wearable device, laptop computer, or other client device can perform the method 300. Methods disclosed herein can operate in several environments and platforms, e.g., as a standalone computer program that can run on any type of computing device, as a web application having web pages, as a mobile application (“app”) run on a mobile computing device, etc. In other implementations, some or all of the method 300 can be implemented on a server device, e.g., a server system 102 as shown in FIG. 1, and/or on both a server device and a client device. In some implementations, different components of one or more servers and/or clients can perform different blocks or other parts of the method 300.

In some implementations, the method 300 can be initiated automatically by a device. For example, the method (or portions thereof) can be performed based on one or more device events such as a command or other input received from a user to display images. Such a device event can cause the device to request one or more of those images from a different device, e.g., if the requested images are not stored in storage local to the device. Other device events can also trigger the method 300. For example, a device can require images (or image identifiers) to process or analyze to create an album or other collection of images for storage and/or display, create thumbnails of images for storage and/or display, send one or more of the images to other devices over one or more communication networks, display and edit an image in an image editing application and user interface, etc. In some implementations, one or more conditions specified in user preferences of one or more users of the device may have been met to cause a request for the images (e.g., user preferences to display images at predefined times, locations, for detected activities, and/or under other predefined conditions). Some implementations can initiate method 300 based on user input. A user may, for example, use a client device to select to display one or more images using a graphical user interface (GUI) of an application program or operating system implemented on the client device.

In block 302, it is checked whether user consent (e.g., user permission) has been obtained to use user data in the implementation of method 300. For example, user data can include user preferences, user biometric information, user characteristics (identity, name, age, gender, profession, etc.), information about a user's social network and contacts, social and other types of actions and activities, content, ratings, and opinions created or submitted by a user, a user's current location, historical user data, etc. One or more blocks of the methods described herein may use user data in some implementations. If user consent has been obtained from the relevant users for which user data may be used in the method 300, then in block 304, it is determined that the blocks of the methods herein can be implemented with possible use of user data as described for those blocks, and the method continues to block 306. If user consent has not been obtained, it is determined in block 305 that blocks are to be implemented without use of user data, and the method continues to block 306. In some implementations, if user consent has not been obtained, the remainder of method 300 is not performed.

In block 306, a request is sent from a device to another device to receive image identification structured data. For example, this request can be sent from a client device to a server system, other client device, or other type of device, where the device receiving the request is referred to as a “server” in this example method due to the role of that device in providing the data. In other implementations, the request can be sent from a server device.

In block 308, the requesting device receives image identification structured data from the server, where the structured data describes groups of selected images in a hierarchy of time scales. Similarly as described above for FIG. 2, in some implementations the image identification structured data can include identifiers of particular images, where the identifiers are based on a collection of images accessible by the requesting device (e.g., a user's collection of images), and the identifiers are stored in one or more hierarchical levels of a hierarchical data structure. In some examples, each level of the hierarchical data structure can represent a different time scale, e.g., an event level (e.g., for events occurring within a day), a day level, a week level, a month level, a year level, etc. In some implementations, the selected image identifiers from each group can be selected from the next lower level of the hierarchy, e.g., the next lower time scale. These selected image identifiers can be selected based on one or more factors, including characteristics of the images and/or other types of factors as described in greater detail below. For example, the selected image identifiers can reference the highest ranked images as evaluated based on these factors. Some examples of such a hierarchical data structure and the determination of the groups of image identifiers are described below with reference to FIGS. 4-7.

In some implementations, the requesting device also receives a timestamp from the server that indicates the time at which the server sent the image identification structured data to the requesting device. In some implementations, the requesting device can store its own timestamp indicating the time of its request in block 306. The timestamp can be used by the requesting device in requesting updates to the image identification structured data, as described below.

In block 310, the device that receives the data in block 308 examines the image identification structured data to obtain one or more identifiers for selected images at a specific time scale. For example, the device may obtain a specific number of image identifiers needed for a particular task of the device that involves the identified images. The obtained image identifiers can be from the groups of selected identifiers stored at the hierarchical level corresponding to the specified time scale. In some implementations, the device can examine the image identification structured data for image identifiers within a specific time period, such as one or more particular dates of interest. Some implementations can obtain identifiers for selected images at multiple different time scales.

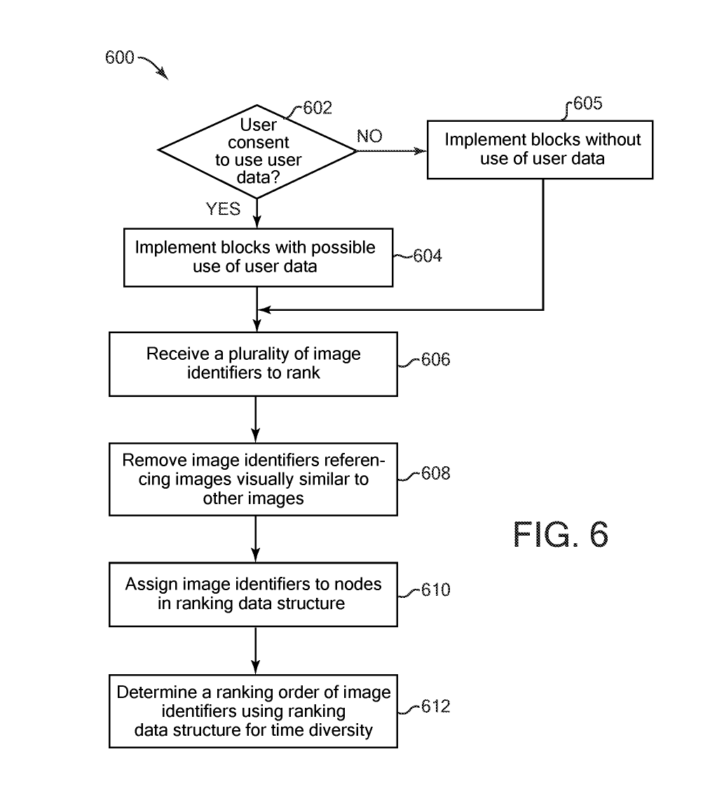

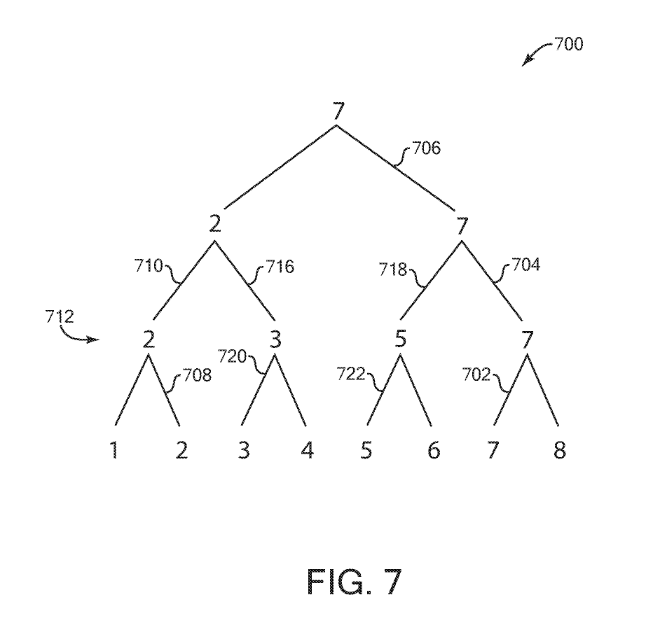

In one example, the device may determine that six images are to be displayed in a graphical user interface displayed on a display screen of the device. The device determines that display of the six highest-ranking images from a particular period of time, e.g., between January and March 2014, is requested and specifies a month level time scale. The device examines the month time scale of the hierarchical data structure (e.g., stored locally at the device) for the three months of January, February, and March 2014 to find selected images from each of those three months. For example, the device can select two highest-ranking image identifiers from each month group, assemble the selected identifiers into six image identifiers, and rank these six identifiers. For example, some example techniques for ranking images are described below with reference to FIGS. 6 and 7. In another example, the device can specify a year level time scale to cover the specified time period that overlaps multiple months. For example, the device can examine the year level of the hierarchical data structure and select the highest-ranking image identifiers from the “Year 2014” group of selected images that have associated time values that fall within the three-month period of January through March. In some implementations, the device can re-rank a plurality of obtained selected image identifiers before determining the specified number of identifiers, e.g., to provide time diversity as described below with reference to FIGS. 6-7.

In block 312, the device requests images that are identified by the image identifiers obtained in block 310. For example, in some implementations this may be a request for a specific number of images corresponding to a specific number of image identifiers obtained from the hierarchical data structure. In some implementations, the device can send the request to a particular server (or servers) that stores and serves the images to requesting devices based on image identifiers sent to that server. In some implementations, the device need not request some or all of the images from a different device if the device stores one or more images in local storage (e.g., a memory cache or other storage).

In block 314, the device receives and processes the images requested in block 312. For example, in some cases or implementations, the processing can include displaying the images on a display of the device (e.g., causing the display of the images by a display of the device). For example, if the device received the images from a server, the device can display the images as they are received, can buffer the images and display one or more images at later times, can display multiple images at approximately the same time, etc. In some implementations, the processing can include other types or forms of processing, such as analyzing or examining the images (e.g., using image recognition techniques to recognize objects or other features, finding watermarks, etc.), creating thumbnails of the images, sending the images to another one or more devices, etc.

In block 316, the device sends a request for an update of the image identification structured data from the server. For example, the device can send a synchronization request to synchronize its image identification structure data with a version of that data stored on a server. In some examples, block 316 can be implemented at a later time after block 308 has been completed. Synchronization of image identification structured data may be necessary or desired in such a case if the image identification structured data stored on the server has changed with additions and/or deletions to images and/or image identifications, e.g., based on input from the device and/or from other devices. In some implementations, the device can receive a message from the server indicating that this synchronization should take place as determined by the server, and the device can send the request in response to receiving this message. In some implementations, the device sends the stored timestamp (received in block 308) with the request, which indicates to the server the last time at which the device requested the image identification structured data from the server.

In block 318, the requesting device receives updated image identification structured data from the server. In some implementations, the server sends only data describing groups of selected images that have had changes after the time indicated by the timestamp sent by the device. For example, the server can store a group timestamp associated with each group of selected images in the hierarchical data structure. The server can compare the group timestamps with the timestamp sent by the device to determine the groups that have been changed and are to be sent to the requesting device. Some examples of updating a hierarchical structure of image identifications are described below with reference to FIG. 4. The server can also send an updated timestamp to the requesting device in block 318 to indicate the most recent time of update for the device.

Following the update of block 318, the device may perform blocks 310-314 again if updating or providing displayed images. In some implementations, the device can update a display of images that was provided before the update of blocks 316-318 by determining if any selected images for display are different after the update. In some cases, the device need only request images that are new to the display after the update and were not previously received and stored on local storage of the device.

FIG. 4 is a flow diagram illustrating an example method 400 to provide a data structure that stores image identifiers at multiple time scales. In method 400, a system creates a hierarchical data structure storing groups of selected identifiers of images that are associated with different time scales at different hierarchical levels of the data structure. Example implementations of such a data structure are described below with reference to FIGS. 5A and 5B.

In some implementations, method 400 can be implemented on a server device, e.g., server system 102 as shown in FIG. 1. In other implementations, some or all of the method 400 can be implemented on a client device (e.g., any of client devices 120-126 of FIG. 1), and/or on both a server device and a client device. In some implementations, different components of one or more servers and/or clients can perform different blocks or other parts of the method 400.

In some implementations, method 400 can be initiated by a device in response to receiving a request for image identifiers at a particular specified time scale, e.g., a request from a different device or process. Some implementations can perform method 400 without such a request, e.g., in a pre-processing or preparation stage of operation to allow the hierarchical data structure to be pre-built and ready for future requests.

In block 402, it is checked whether user consent (e.g., user permission) has been obtained to use user data in the implementation of method 400. For example, user data can include user preferences, user biometric information, user characteristics (identity, name, age, gender, profession, etc.), information about a user's social network and contacts, social and other types of actions and activities, content, ratings, and opinions created or submitted by a user, a user's current location, historical user data, etc. One or more blocks of the methods described herein may use user data in some implementations. If user consent has been obtained from the relevant users for which user data may be used in the method 400, then in block 404, it is determined that the blocks of the methods herein can be implemented with possible use of user data as described for those blocks, and the method continues to block 406. If user consent has not been obtained, it is determined in block 405 that blocks are to be implemented without use of user data, and the method continues to block 406. In some implementations, if user consent has not been obtained, the remainder of method 400 is not performed.

In block 406, a set of image identifiers for a set of images in a hierarchical data structure are stored. In some examples, the set of images can be a collection of images associated with a particular user or user device, such as a large collection of images (e.g., hundreds or thousands of images) captured by the user (e.g., with cameras) and/or otherwise obtained by and accessible to the user. In some implementations, the set of image identifiers can be stored in the data structure, e.g., in a lowest level of the hierarchical data structure. Some implementations can store the set of image identifiers separately from the hierarchical data structure. In some implementations, the set of image identifiers can be ordered according to a time value associated with each referenced image, e.g., a timestamp indicating time of capture of the image or other associated time, so that the image identifiers are ordered similarly to a timeline.

In block 408, event sets are determined in the set of image identifiers. In some implementations, the set of image identifiers is organized into a plurality of “event sets” where each event set includes image identifiers for images occurring within a single defined event in the timeline of images. In some implementations, an event set can be defined by a start time, end time, and the image identifiers included within that event set. In some examples, an event set can be defined by a start time and an end time, and includes the image identifiers that have a time value between the start time and the end time.

An event set can be determined in any of a variety of ways. Some implementations can place each image identifier in only one event set, and image identifiers having a time value close to each other are considered to be in the same event set. For example, a large gap or time interval between image identifiers can be considered a division between one event set and the next (adjacent) event set, where the time interval is equal to or greater than a threshold time interval. In some example implementations, a threshold time interval of 3 hours (or greater) between images can divide event sets. In various implementations, the threshold time interval to divide event sets can vary, e.g., 1 hour, 2 hours, 5 hours, etc. In some implementations, event sets can be determined based on additional or alternative factors besides time intervals between images, including one or more other characteristics of the referenced images (if user consent has been obtained). In some implementations, one or more of a similarity of recognized objects depicted in images, image colors, shadows, etc. may be used to determine event sets. In some implementations, other user data such as geographic locations (e.g., stored as location metadata with the images), calendar events and user activity data (e.g., available, with user consent, from a user's device or user account in an online service), etc. may be used to determine event sets.

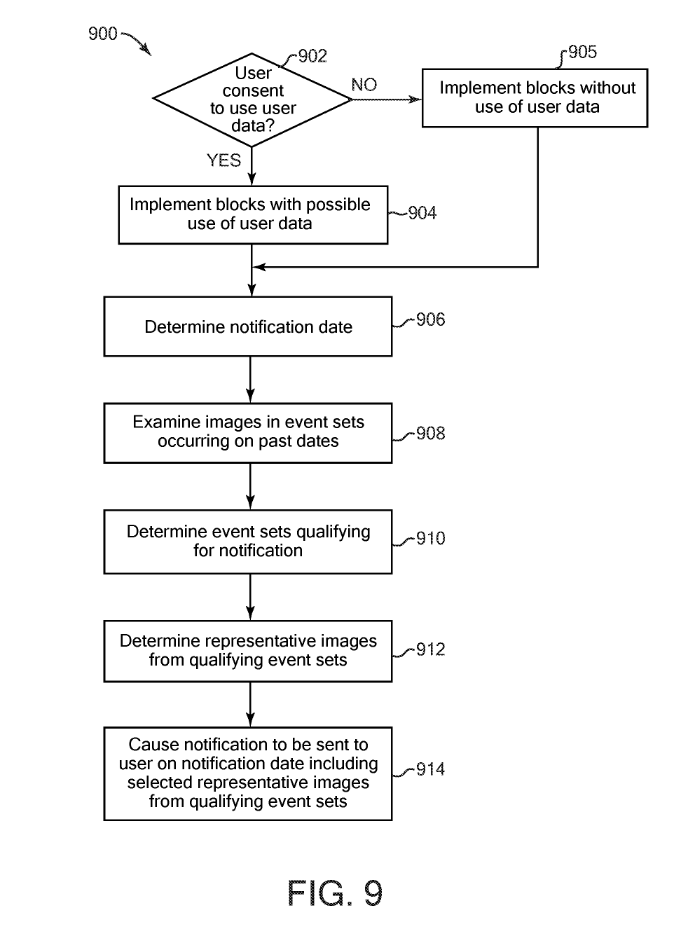

Some implementations can also distinguish between different types of event sets. For example, more important or memorable events can be defined as “highlighted events,” where a particular set of factors can be used to find a highlighted event in the set of images and/or qualify an event set as a highlighted event set. For example, some implementations can use one or more different and/or additional factors to find highlighted events compared to events, e.g., highlighted events can be found using one or more factors as described below with reference to the notifications of FIG. 9. For example, such factors can include, if user consent has been obtained, determining whether designated faces/landmarks/objects are recognized within image content indicating events such as holidays, parties, vacations, etc., and/or using user data to determine importance of recognized content to the particular user. In some implementations, event sets can be defined within predetermined time period boundaries and do not extend across any such boundary. For example, event sets can be defined within day boundaries defined at a predetermined time each day (e.g., 12:00 AM), or within other time period boundaries. Some implementations can allow event sets to span a time period longer than a day or other defined time boundary.

In block 410, event groups of selected image identifiers are determined and stored for a first hierarchical level of a data structure that represents a first time scale. In some examples, the first hierarchical level can be the bottom or lowest level of the hierarchical data structure as in the examples described with respect to FIGS. 5A and 5B. Other implementations can place the first hierarchical level at other positions within the hierarchy (e.g., the top). In some examples, the first hierarchical level can be a lowest level in the hierarchy representing an event level time scale that organizes image identifiers into the event sets described above. Some implementations can define a different time scale for the first hierarchical level.

The event groups of selected image identifiers can be determined based on ranking orders of image identifiers in event sets. For example, in the example of a first hierarchical level at an event level time scale, an event level group of selected image identifiers can be determined for each event set, based on a ranking order of the image identifiers in the associated event set. In various implementations, the ranking order can be determined for all the image identifiers in the event set, or determined for a number of image identifiers in each event set.

A ranking order of image identifiers can be based on one or more factors. In some implementations, the factors can include one or more characteristics of the images, e.g., pixel characteristics, geographic location associated with the respective image, user data, and other factors. Some examples of factors are described below with reference to FIG. 6. Furthermore, the ranking order can be based on a time diversity of the image identifiers in the event set. Images that have a greater time interval between them have a greater time diversity. Such images may be more likely to have diverse content than images having a smaller time interval between them (e.g., the images depict content that differs to greater degree from each other than the images having the smaller time interval). In some implementations, a tree structure can be used to quickly and efficiently determine a ranking of the images in the set of images, based on one or more of the factors described above. Such implementations may efficiently incorporate time diversity between the images as a factor in the ranking order. Some example implementations of a tree structure are described below with reference to FIG. 7. Some examples of determining a ranking order are described below with reference to FIG. 6.

In block 412, one or more groups of selected image identifiers are determined and stored for the next hierarchical level of the hierarchical data structure, e.g., next to the last-determined hierarchical level (which can initially be the event level in one example). In some implementations, the next hierarchical level with respect to the event level represents a day time scale with day time periods, such that the determined groups are day groups representing particular day time periods of the timeline and each day group represents a corresponding day. In some implementations, the next hierarchical level is a second level of the data structure representing a second time scale.

In some implementations, the selected image identifiers of a group can be determined based on a ranking order of image identifiers obtained from one or more groups of selected image identifiers at the next lower hierarchical level, which can be groups at the event level (e.g., “event groups”) in one example. For example, the image identifiers in those groups at the event level that correspond to the time period of a particular day group can be assembled and provided in a ranking order, and the resulting highest ranking image identifiers can be placed in that day group. For example, a predetermined number of the highest ranking image identifiers can be placed in the day group, such as 2, 10, 50, etc. In some implementations, by examining and ranking a subset of image identifiers in appropriate groups of the lower level, the need for ranking all of the images occurring in the associated time period (e.g., day) can be reduced or eliminated.

In block 414, one or more groups of selected image identifiers are determined and stored for one or more other hierarchical levels of the hierarchical data structure. For example, to determine these groups at other hierarchical levels, block 412 can be repeated for different levels of the hierarchical data structure.

In some examples, if the groups of selected image identifiers have been determined for a hierarchical level representing a day level of time scale, the next level can represent a week level defining week time periods. One or more week groups of selected image identifiers can be determined based on appropriate day groups of selected image identifiers at the lower level. For example, for a week with seven days, the image identifiers from the day groups of all of those seven days are assembled and ranked. The resulting highest ranking image identifiers can be placed in that week group. For example, a predetermined number of the highest ranking image identifiers can be placed in the week group, such as 2, 10, 50, etc.

This determination can be repeated for each other hierarchical level. For example, for a hierarchical level at a month level time scale, each month group of selected image identifiers can be a predetermined number of highest-ranked image identifiers. Those image identifiers can be obtained from each week group falling within that month time period. Similarly, for a hierarchical level at a year level time scale, each year group of selected image identifiers can be a predetermined number of highest-ranked image identifiers obtained from month groups falling within the year time period. In some implementations, only a subset of the image identifications in one or more lower groups are used to determine the higher level group, based on the timestamps of the image identifiers falling within the time period of the higher level group. For example, a month group may only need some of the image identifiers in a week group, since the week crosses month boundaries and the month does not include all of the days of that week. For example, the image identifications having timestamps occurring in the days of the month can be obtained from that week group.

Thus, groups of selected image identifiers can be determined for each level of the hierarchical data structure based on image identifiers from the level below that level. Each additional hierarchical level stores one or more groups of highest-ranking image identifiers derived from one or more groups of highest ranking image identifiers at the next lower level of the data structure. In various implementations, the highest ranking image identifiers can be obtained from one or more lower levels of the data structure, e.g., levels including or not including the next lower level of the data structure.

In some implementations, the rankings of the image identifiers can be stored with (or associated to) each time period group at each hierarchical level. For example, each day group at the day level in the hierarchical data structure can store the ranking order of the image identifiers in that group. In some implementations, each time period group of selected image identifiers can be defined by its start time, end time, selected image identifiers in that group, and ranking list of those selected image identifiers.

In some implementations, the image identifiers for the set of images and the determined groups of selected identifiers can be sent to a requesting device. For example, a device may have requested to receive image identification structured data, as described above with reference to FIGS. 2 and 3. The hierarchical data structure may have been pre-processed and can be ready for use by the requesting device. In some implementations, providing the hierarchical data structure (or a portion thereof) to the requesting device allows the requesting device to refer to the one or more groups of selected image identifiers to determine highest ranked images from the set of images at different desired time scales and time periods.

In some implementations, a day group of selected image identifiers can be determined based on all the image identifiers within the time period covered by the day, e.g., without regard to event sets. For example, higher level groups than the day level groups can be determined based on one or more of the next lower level groups.

The hierarchical data structure can be updated based on one or more images being added to the set of images, and/or one or more images being removed from the set of images. In some implementations, if a new image is received in the set of images, updates can include merging two event sets into one event set, e.g., if the new image causes the time interval between images to be under the threshold for event set division. In some cases, a new image can enlarge the time range of an existing event set, or cause a new event set to be added to the timeline of images. Furthermore, the addition of the new image to an event set may cause the system to re-evaluate all the groups that cover the time value associated with the new image. Some examples of updating the data structure are described below with reference to FIG. 5A.

In some implementations, event labels can be determined and associated with event sets stored in the hierarchical data structure. An event label is a descriptor for an event set, e.g., a text description, image, symbol, or other description that describes the event represented by the event set. In some implementations, the method 400 can obtain individual labels for one or more of images that are identified by the identifiers grouped into the event sets. These individual labels can be collected and an event label can be generated based on these individual labels and/or other factors. In some examples, individual labels of “cake,” “candles,” “persons,” and “presents” from individual images can be collected and compared to a predetermined list of event labels (or other labels) associated with individual model labels. If a threshold number of individual labels match the model labels of a particular event label on the list (e.g., “birthday party”), that event label can be assigned to the event set having the images with those individual labels. Some implementations can assign each individual label a weight based on its semantic similarity to an event label, and determine an event set label based on a total score contributed to by the weights of individual labels. Some implementations can examine timestamps associated with individual images to determine if the images occurred at a holiday, birthday (e.g., based on user calendar data), or other known event. Such matching with a known event can supply an event label to the event set having those images. Some implementations can label an event set with event labels that are the same as one or more individual labels obtained from the images in that event set. In some implementations, a request for image identifiers from the hierarchical data structure can provide one or more search terms associated with the request. Search terms can be compared to event labels to find event sets matching the search terms. For example, a group of selected image identifiers from the matching event set, or all of the image identifiers from the matching event set, can be provided to the requestor.

FIG. 5A is a diagrammatic illustration of an example of a hierarchical data structure 500 that can be used with one or more features described herein. For example, the hierarchical data structure can store image identifiers (IDs) according to different time scales as described herein. In some implementations, the hierarchical data structure can be determined similarly as described above with respect to FIG. 4.

Hierarchical data structure 500 stores image identifiers for a set of images according to different time scales of a timeline composed of images as described herein. Data structure 500 can alternatively or additionally be considered to include multiple data structures, e.g., a data structure for each time scale. In this example, an event level 502 of the data structure is shown at the bottom of the hierarchy, a day level 504 is at the next higher level in the hierarchy, a week level 506 is at the next higher level in the hierarchy, and a month level 508 is at the highest level of the hierarchy. Other levels can be used in other implementations, including a year level, decade level, or levels representing another time scales.

Event level 502 organizes image identifiers into event sets based on events detected from the associated images. In this example, the image identifiers 512 are ordered from left to right based on their time data (e.g., timestamps indicating date and time of capture or date/time of occurrence), with the earliest time at the left and the latest time at the right of the timeline. Event sets 514 (e.g., numbered as event sets 1-10 in this example) can be determined based on time intervals between images and/or other factors as described above, as well as day boundaries 516. In this example, the first day defined by the day boundaries 516 is Friday, January 30, followed by Saturday, January 31 and Sunday, February 1. For example, image IDs 512 are ordered in time order within each event set 514. In this example, five event sets (1-5) are determined for the day of Friday the 30th, three event sets (6-8) in the day of Saturday the 31st, and two event sets (9-10) in the day of Sunday the 1st. Event set 1 includes image identifiers 1 and 2, event set 6 includes image identifiers 11 and 12, and so on.

In some implementations, groups 518 of selected image identifiers are determined for each event set, providing highly-ranked images from each event. For example, a predetermined number of image identifiers from the next lower hierarchical level can be stored in each group of the current level. Each event group in this example has 1 image identifier. In this example, the group 518 for event set 1 includes image ID 2 which was the highest ranked image identifier in that event set. Similarly, the group for event set 3 includes image ID 5 which was the highest ranked image identifier in that event set. Other implementations can provide a greater number of highest ranked images in each group (if available from that event set). In some implementations, event sets and event groups can be stored at the same hierarchical level as day groups.

Day level 504 is the next hierarchical level in this example. The day level 504 stores groups of image identifications determined for each day. The day level 504 includes several day time periods, each of which is determined based on time (e.g., 12:00 AM to 11:59 PM) and represents a specific date (e.g., Friday, Jan. 30, 2015). The day level 504 can include several days, e.g., all the past days in which the set of images have time values occurring. Each day covers a number of image IDs 522 falling within that day's time period based on their time values (timestamps), such as image IDs 1-10 for Friday January 30th, image IDs 11-16 for Saturday January 31st, image IDs 17-20 for Sunday February 1st, etc. (The vertical lines dividing time periods in each time scale in FIG. 5A are not aligned with corresponding vertical lines in other time scales shown.)

In addition, each day is associated with a group 524 of selected image IDs. In some implementations, a group of selected image IDs of a particular level of the hierarchical structure can be determined based on one or more groups of selected image IDs at the next lower level of the hierarchy which cover a similar time period covered by the group of the particular level. In this example, each day group 524 is determined from the event groups 518 of selected image identifiers that fall within that day time period. For example, a predetermined number of the highest ranking image identifiers from the event groups within that day's time period are stored in the day group 524. In this example, the image IDs 2, 3, 5, 7, and 9 are obtained from the event groups 518 that correspond to the day of Friday January 30 (here, event groups 1-5). These image IDs are ranked (e.g., as described herein) and the two highest ranking image identifications are stored as the group of selected image IDs for that day. In this example, the two highest ranking image IDs are 2 and 5, in that order (e.g., 2 having the highest ranking). The ranking order within the group is shown in FIG. 5A by the order of the image IDs in the group 524. In some implementations, each image ID in the group 524 has its ranking stored in the group in association with its image ID. Thus, if a request is received for the two highest ranked image identifiers for particular dates at the day timescale, the system can provide the two highest ranked image IDs within each group 524 for the requested dates. Some implementations can store less than the predetermined number of image identifiers associated with that group, e.g., if there are not sufficient image identifiers in the next lower hierarchical level, if one or more of the image identifiers at the next lower level do not qualify to be included in the group (e.g., based on image characteristics and/or other factors described herein), etc.

In this example, the two highest ranked image identifiers are stored in the group 524 for each day time period. Other implementations can store a different number of highest ranking image identifiers, such as a much larger number (e.g., 50, 1,000, etc.), if that number of image identifiers are available for that particular day. In some implementations, all of the image IDs from the corresponding lower level groups can be ranked and stored in the groups 524 with their rankings. For example, the Friday 30th day group can store all of the image identifiers 2, 3, 5, 7, and 9 from the corresponding event groups as well as their rankings. In some implementations, not all of the image identifications are ranked and provided in group 524. For example, some image identifications can be removed from consideration as described with reference to FIG. 6, e.g., identifying images that are visually similar to one or more other images.

Week level 506 of the hierarchical data structure is provided at a level above the day level 504 in this example. The week level 506 can include several week time periods, e.g., all the past weeks in which the set of images have time values occurring. Each week time period can be a specific week of a particular month, such as the 5th week of 2015 (e.g., the last week of January) and the 6th week of 2015 (e.g., the next week, in February), and so on. Each week time period covers a number of image IDs 532 falling within that week based on the timestamps of the image IDs, such as image IDs 1-20 in Week 5 and image IDs 21-39 in Week 6 in the example shown.

Each week time period can be associated with a group 534 of selected image IDs determined from groups of selected image IDs determined at the day level and occurring in that week. For example, a week group 534 can include image IDs that have been determined to have the highest rankings among the images stored for that week, similarly as for each day at the day level 504. In some implementations, each image ID in the group 534 has its ranking stored in association with the image ID. In some implementations, a predetermined number of the highest ranked image IDs among the image IDs of that week can be stored in each group 534, such as two in this example.

In this example, weeks are defined as Monday through Sunday, and Week 5 at the week level covers a time period that includes the days Friday January 30th, Saturday January 31st, and Sunday February 1st at the day level, as shown. Week 5's time period is also covered by the days Monday January 26 through Thursday January 29th that are previous to Friday January 30th (not shown in FIG. 5A). Week 5's group 534 can be determined from the groups 524 of the days Monday January 26 through Sunday February 1. The image IDs from these day level groups can be assembled and ranked for the Week 5 group using the same method as ranking the groups 524. The resulting group 534 for Week 5 in this example includes the highest ranking image IDs 2 and 11 (from Friday, January 30 and Saturday, January 31, respectively).

Month level 508 of the hierarchical data structure can be provided at a level above the week level 506 in this example. The month level 508 can include several month time periods, e.g., all the past months in which the set of images have time values occurring. Each month time period can be a specific month of a particular year, such as January 2015, February 2015 (as shown), etc. Each month time period covers a number of image IDs 542 falling within that month, such as image IDs 1-16 for January and image IDs 17-58 for February in the example shown.

Each month time period can be associated with a group 542 of selected image IDs determined from the groups of selected image IDs determined at the week level and occurring in that month. For example, a month group 544 can include image IDs that have been determined to have the highest rankings among the images stored for that month, similarly as for each day at the day level 504 and each week at the week level 506. Each image ID in the group 544 can have its ranking stored in association with the image ID such that the image IDs within the group 544 have a particular order based on the rankings. In some implementations, a predetermined number of the highest ranked image IDs among the image IDs of that month can be stored in each month group 544, such as two in this example.

In this example, two months are defined as January 2015 and February 2015, and January at the month level covers a time period that includes a portion of Week 5 (Monday January 26th through Saturday January 31st) at the week level. The time period for January is also covered by Weeks 1-4 that are previous to Week 5 (not shown in FIG. 5A). The group 544 for January of selected image identifications therefore can be determined from the groups 534 of the Weeks 1-5. In some implementations, the image IDs from the groups of Weeks 1-5 can be assembled together and ranked for the month level group 544 using the same method as ranking the groups 534 and 524. The resulting group 544 for January in this example includes the image IDs 2 and 11 (from Week 5, and assuming the image IDs from Weeks 1-4 are ranked lower than these).

A year level on a year time scale can be similarly determined above the month level 508. Levels at other time scales can be determined in some implementations, e.g., at other positions within the hierarchy. In some implementations, each time scale level of the hierarchy can be associated with a different predetermined number of selected images in the groups of that time scale level. Some implementations can assign different predetermined numbers of selected images to different groups at the same time scale level.

As shown in FIG. 5A, some image identifiers can be stored at multiple levels. For example, a high ranking image identifier in a particular event set may be sufficiently high ranked to be selected for storage in higher levels of the hierarchical data structure, such as the appropriate day group, week group, month group, etc. In FIG. 5A, for example, image ID 2 is ranked highest at the four shown levels of the hierarchy and appears in groups at all four levels. In some implementations, this allows a memorable and high-quality image in a set of images to be seen at multiple time scales.

The data structure can allow a system to determine a group of selected image IDs for a particular higher time scale based on the appropriate groups from the next lower level time scale. In some implementations, this feature can provide considerable processing savings in comparison to other methods. For example, reduced numbers of images indicated in the appropriate groups from a lower level can be examined and ranked rather than examining and ranking all of the images falling in the desired time period.

An update can occur to the hierarchical data structure 500 based on one or more images being added to the set of images, and/or one or more images being removed from the set of images. For example, an associated user can capture and/or store additional images for his or her collection, where the new images have new (current) time values and/or old time values (e.g., photos obtained in the past and only now being provided to a system maintaining the data structure 500).

If an update occurs with a new image that is added to the set of images, in some implementations the system can check in which time period a new image ID for the new image should be stored at the lowest level of the hierarchy, and add the image ID for the new image to that lowest-level time period (e.g., an event level in this example). The system can also re-process affected groups at the higher levels of the hierarchical data structure based on the new image. For example, the system can re-rank the image IDs in the appropriate event group 518 that was updated by the new image and determine a new event group 518 for that event set.

In some example implementations, if an event group 518 is changed due to the new image (e.g., the new image displaced an older image ID in the higher rankings), then the system can determine which day group 524 is in the time period including the new image, and determine a new group 524 for that day including the new day groups 526 in that determination. In addition, the system can determine which week group 534 is in the time period including the new image, and determine a new group 534 for that week including the new day group 524 in that determination. For example, to determine this new week group 534, the system can assemble the new day group of IDs as well as retrieve the previously-stored day groups of IDs for the other days in that week, and then re-rank these assembled IDs using the same techniques to determine the new groups as described above. The newly-ranked group can then replace an existing group corresponding to the same week time period.

Similarly, if a week group 534 is changed due to the new image, then the system can determine which month group 544 covers the time period of the new image, and determine a new group 544 for that month by including the new group 534 in that determination. For example, the system can assemble the new week group 534 as well as previously-stored sibling week groups 534 covering the remaining time period of the month, and then re-rank the assembled IDs to find the new month group 544. This can be repeated for other affected levels of the hierarchy.

In some implementations, if an update removes an image from the set of images, the system can analogously re-process affected groups in the hierarchical data structure as for added images. For example, removal of an image identifier that was included in a group of selected image identifiers can cause a different set of image identifiers to be ranked for that group and for one or more other groups covering the time value of the removed image.

In some implementations, the system can store an updated timestamp for each updated group, indicating the time at which that group was changed due to the update. For example, an event group 518 that was changed by the addition of a new image can receive a current timestamp, and other groups 524, 534, and/ 544 that changed due to the addition can also receive a current timestamp. In some implementations, if the hierarchical structure (or portion thereof) was previously sent to a device, and the device requests an updated version of the data structure, the system can examine the timestamps. For example, the system can examine the timestamps of the groups of the structure to find groups that were updated after the last time the device received an update. The system can send only the updated groups to the device. (The system can also send the image identifiers for any new images and removed images.) This can allow the system to send an incremental update of only the updated groups to a requesting device instead of sending all the data in the data structure.

FIG. 5B is a diagrammatic illustration of another example of a hierarchical data structure 550 that can be used with one or more features described herein. For example, the hierarchical data structure can store image identifiers (IDs) according to different time scales as described herein. In some implementations, the hierarchical data structure can be determined similarly as described above with respect to FIG. 4.

In this example, image identifiers 554 are shown at a bottom level 552 of the hierarchy (or can be considered outside the hierarchy of the hierarchical data structure). For example, these identifiers can refer to a set of images, e.g., a collection of images associated with a user. In this example, these image IDs are ordered in a time order from left to right (other orders can be used in other implementations, e.g., an order based on a different value associated with the identified images). The next level 560 is an event level, where events 562 of image identifiers are determined and delineated, e.g., based on time intervals between the time values of the identified images and/or other factors as described above. In some implementations, each event 562 includes an event set (group) 564 of selected image identifiers selected from the time period represented by that event 562. In some implementations, the selected image identifiers can be the highest ranked image identifiers from that time period, for example, as described above. In this example, three image identifiers are provided in each event set 564. Image identifiers 2, 4, and 5 are selected as the highest ranking image identifiers from the event between 17:00 and 19:00 on January 28, and are stored in that event set 564. Some implementations can store additional information with the event set 564, including a start time, end time, and title, e.g., describing the event or one or more images included in the event. For example, the title can be determined as an event label as described herein, or can be one or more descriptive labels from images in the event set 564, can be assigned by a user, or can be determined in other ways.

The next level 570 can delineate a week time scale. In this example, there is no day level time scale, and the week time scale directly obtains image identifiers selected from the appropriate event sets 564 of the event level 560 to place in week groups 572 of selected image identifiers. In this example, two image identifiers are provided in each week group 572. Image identifiers 2 and 4 were found to be the two highest ranking image identifiers from the event set on January 28 and are placed in the week group 572 for Week 4 of 2014. Image identifiers from other event sets occurring in the time period of Week 4 of 2014 are also examined and potentially included in the week group (not shown). In this example, Week 4 also has a title associated with its week group 572, e.g. determined automatically based on the images and/or based on user input.

The next higher level 580 can delineate a month time scale. In this example, two image identifiers are provided in each month group 582. Image identifiers 2 and 50 were found to be the two highest ranking image identifiers from week groups occurring in January 2014 and are placed in the month group 582 for January 2014. One image identifier 53 was found from week groups occurring in February 2014 (e.g., Week 5) and stored in the month group 582 for February 2014.

In the example of FIG. 5B, vertical lines shown separating different time periods are aligned across different time scale levels of the hierarchical data structure 500. This indicates how groups of selected images can span time periods having boundaries that do not align with boundaries of time periods at other time scale levels of the hierarchical data structure 500. For example, time period boundaries at one time scale can occur within time periods at other time scales. In one example, the boundary 590 between January 2014 and February 2014 time periods splits Week 5 into two portions, one portion occurring in January and the other portion occurring in February. Thus, the system can examine image identifiers in multiple weeks (e.g., Weeks 4 and 5) at the week level 570 for possible inclusion in the January group 582 at the month level 580. In some implementations, the image identifiers examined in Weeks 4 and 5 can be only those image identifiers having time values occurring within the desired month of January 2014. For example, only image identifier 50 in Week 5 was examined for January 2014 because image identifier 53 in Week 5 occurred in February 2014.

FIG. 6 is a flow diagram illustrating an example method 600 to provide a ranking data structure that enables ranking of images based on one or more image characteristics. In some implementations, method 600 can be implemented on a server system, e.g., as shown in FIG. 1. In other implementations, some or all of the method 600 can be implemented on a client device, and/or on both a server system and a client system.

In some implementations, method 600 can be used to determine the groups of image identifiers (IDs) at different hierarchical levels of a hierarchical data structure described herein. Some implementations can use a ranking data structure to provide an efficient way to determine a ranking order of images based on visual quality, image content, and other characteristics and factors, as well as time diversity of the images. For example, time diversity can be efficiently promoted by selecting different portions (e.g., branches) of the ranking data structure for successive image identifiers in the ranking order, to cause greater separation in time values (e.g., timestamps) of successively ranked image identifiers.

In block 602, it is checked whether user consent (e.g., user permission) has been obtained to use user data in the implementation of method 600. For example, user data can include user preferences, user biometric information, user characteristics (identity, name, age, gender, profession, etc.), information about a user's social network and contacts, social and other types of actions and activities, content, ratings, and opinions created or submitted by a user, a user's current location, historical user data, etc. One or more blocks of the methods described herein may use user data in some implementations. If user consent has been obtained from the relevant users for which user data may be used in the method 600, then in block 604, it is determined that the blocks of the methods herein can be implemented with possible use of user data as described for those blocks, and the method continues to block 606. If user consent has not been obtained, it is determined in block 605 that blocks are to be implemented without use of user data, and the method continues to block 606. In some implementations, if user consent has not been obtained, the remainder of method 600 is not performed.

In block 606, a plurality of image identifiers (and their referenced images) are received to rank. For example, in some implementations each image identifier identifies an associated image, e.g., as described herein. In some implementations, the image identifiers can be from a particular time period, and/or from one or more groups of selected image identifiers from a hierarchical structure, such as particular event groups, day groups, week groups, etc. The identifiers can be ordered in a time order, e.g., based on the time values of their associated images.

In block 608, image identifiers are removed from the received identifiers, where the removed identifiers are determined to reference images that are visually similar to other images being ranked, e.g., by a threshold similarity. In some implementations, a linear scan of adjacent images (e.g., adjacent based on their time values, in the time order) is performed, where adjacent pairs of images are compared to each other to determine visual similarity. In some example techniques, corresponding pixels can be compared for similar color, brightness, etc. In other techniques, a signature vector or other fingerprint can be determined for each image based on the pixel content of the image and the vectors can then be compared for similarity. Other similarity determination techniques can alternatively be used, e.g., comparing extracted image features, comparing histograms based on hue or other characteristics of pixels in the images, etc.

In some implementations, if adjacent images are found to satisfy or exceed a predetermined threshold similarity, the corresponding image identifiers are grouped together. After such similarity groups are formed based on adjacent visual similarity, the method can remove (e.g., delete or mark to ignore) the image identifiers for images that are considered too similar (e.g., satisfying the similarity threshold), leaving a single image identifier for each similarity group. For example, this can cause identifiers for duplicate or near-duplicate images to be removed. In one example, an image characteristic score (e.g., based on visual quality, image content, and other factors as described below) can be determined for each image identified in the similarity group. An image from the similarity group having the highest score can be considered the single image identified for that group while the other images of the group are removed. Other implementations can retain one or more lower scoring image identifiers for potential ranking. Some implementations can omit block 608.

The comparison of adjacent image identifiers in the time order (e.g., using linear scan) can save processing resources in comparison to doing a piecewise comparison of each image to each other image. Some similarity matches may be overlooked by using only adjacent comparisons; however, some implementations can find such overlooked similarities later in the method 600 by doing a piecewise comparison on a smaller number of images, e.g., performing such a piecewise comparison on the ranked images resulting from block 612.

In another example, similarity processing include comparing, for visual similarity, images referenced by adjacent image identifiers in the time order, grouping image identifiers for similar images in similarity groups, and selecting an image identifier from each similarity group for assignment to one of the nodes of the ranking data structure. Each image identifier assigned to one of the nodes has a highest image characteristic score of the image identifiers in the associated similarity group.

In block 610, image identifiers are assigned to positions or nodes in a ranking data structure. In some implementations, this ranking data structure can be a tree, e.g., a binary tree as in the example of FIG. 7 described below. The ranking data structure can take different forms in other implementations, e.g., other types of trees or graphs. In some implementations, the image identifiers are ordered in a time order in the data structure such that image identifiers closest in time values are adjacent to each other.

In block 612, a ranking order of the image identifiers is determined using the ranking data structure to provide time diversity of successively-ranked images. For example, this block can cause successively-ranked image identifiers to be nonadjacent in the time order of the image identifiers. For example, succeeding ranked image identifiers (e.g., neighboring in the ranked order) are separated in the time order by one or more other image identifiers. This feature can provide a greater time interval between successively ranked images, e.g., a greater time diversity and a reduced time similarity of successively-ranked images. This can result in better ranking of images of interest to a user. For example, users may like to see featured images from a particular time period that are different than each other, and two images captured with a greater time interval between them may tend to be more different than two images captured closer in time to each other.

In some implementations, determining the ranking order includes using a score determined for each image identifier that is based on one or more factors related to image characteristics of the image referenced by the identifier. The overall score that includes these one or more factors is a combination score referred to as an “image characteristic score” herein. An “image characteristic” can be any characteristic related to an image, including characteristics of image pixels and image content, characteristics related to timestamps, location data, and other metadata of the image, and characteristics related to one or more users associated with the image (e.g., user data including user calendar data, user activity data, etc.). User data is obtained only if consent of the user(s) providing and described by that data has been obtained. Determining the ranking order can include determining the image characteristic score for each of the images, where a better image characteristic score weights an image to a higher rank than a worse image characteristic score.

In some examples, the image characteristic score can be based on one or more of a variety of factors (e.g., parameters). Such factors can include visual quality characteristics related to the visual appearance of the image. These can be characteristics indicating technical visual quality, such as blurriness, exposure level, brightness, contrast, blurring/sharpness, exposure level, saturation, highlights, shadows, vibrance, color noise (and/or other types of visual noise), image resolution, and/or other types of visual quality characteristics in the image. Some implementations can use image quality analysis based on pixel values (such as color and brightness values) and/or based on structures or objects detected in the pixels, e.g., edges and textures. A visual quality characteristic can include image composition, where images are scored based on the location of the main subject(s) in the image with respect to the borders of the image, other objects in the image, etc. Visual quality characteristics can also be based on local regions in the image composed of multiple pixels.

Factors to influence the image characteristic score can also include content characteristics related to content depicted in the image (e.g., persons, animals, objects, landscape features or areas, environments, etc.). Image content can be detected and recognized based on any of various known image recognition techniques, including facial recognition techniques, landmark recognition techniques (e.g., well-known landmarks), landscape recognition techniques (e.g., foliage, mountains, lakes, etc.), object recognition techniques (e.g., vehicles, buildings, articles, etc.). Permission is obtained from users or persons who are depicted in images and who may be recognized in the images. For example, different weights can be assigned to different particular types of content. In one example, popularly appealing image objects such as faces (identity of persons is not obtained), landmarks, sunsets, beaches, flowers, and animals can be given higher weights and can contribute to a higher image characteristic score than other types of features.

The factors influencing the image characteristic score can also include image metadata stored with or associated with the image, including EXIF data, timestamps, geographic locations associated with the image (e.g., location of capture of the image), and one or more descriptive labels describing the content (e.g., text labels or tags). For example, this data can assist the recognition of content in the image, and/or can indicate which images may be preferable to a user based on known user preferences (e.g., the user prefers particular locations such as a local park, prefers certain subjects such as parties known from descriptor labels, etc.).

The factors influencing the image characteristic score can also include user data related to a user who is associated with the image. For example, user data can be obtained, with the user's permission, from a user's device and/or user account in an online service. The user data can include user preferences (e.g., to determine which image content, depicted times of day, and characteristics may be preferred by an associated user), calendar information of a user associated with the set of images (e.g., to help determine image content subjects, locations, etc.), user activity historical data describing one or more activities of the user (e.g., to help determine health of user at time depicted in image, user-preferred friends, locales, events, and activities, etc.), social user data (e.g., messages to and from other users, shared content with other users, rankings of content made by the user, etc.), etc.

Some implementations can use machine learning techniques based on training with training images for how to score particular factors detected for an image. In some implementations, visual quality characteristics indicating high visual quality can be known from machine learning techniques and training techniques, e.g., where users previously rated or judged a large number of images and the machine learning techniques are trained with looking for the characteristics of the highest user-rated images in other, unrated images, e.g., a system can learn which characteristic values or patterns are indicative of better scores and higher ranks.

Some implementations can examine one or more of the above factors from time periods occurring before and/or after the time period including the set of image identifiers. For example, one or more groups of selected image identifiers can be examined from the hierarchical data structure that occurred previously to the time period of the image identifiers being examined in FIG. 6, and/or later than that time period. In some examples, groups of selected images can be examined from time periods occurring one or more weeks ago, one or more months ago, one or more years ago, etc. relative to the set of image identifiers being ranked. In some implementations, one or more recurring patterns can be looked for in the factors of the images from these previous time periods. In some examples, if particular image characteristics such as recognized content, geographic location, visual characteristic, user data, or other image characteristic exist in one or more images on an annual date over multiple years, then the image characteristic scores of images having those recurring characteristics can be weighted higher in the ranking determination of method 600. This can allow a system using method 600 to (with consent of the user) learn user preferences and habits over time and to select images that are more significant to the user. In some implementations, images with such recurring characteristics can be weighted lower in the ranking determination, e.g., if more image content differentiation is desired in selected images from different groups.

The image characteristic score can be used in conjunction with selection based on time diversity as described above, to determine the ranking position of the image identifiers. For example, in some implementations, the best (e.g., highest) scoring image identifier can be ranked highest, and succeeding placement of image identifiers in the ranking order can be based on both their score as well as their time diversity from the image identifier just previous in the ranking order.

In some implementations, the selection of time-diverse successive image identifiers in the ranking order can be performed efficiently by using a tree structure as the ranking data structure. In some implementations, an image identifier is assigned to one or more higher nodes in the tree if it has a higher score than one or more other image identifiers at the same level(s) in the tree, thus using branches of the tree to move to higher nodes. After selecting a ranked image identifier, unused branches and/or nodes of the tree structure can be used to select the next ranked image identifier, thus promoting time diversity of successively-ranked images. Some examples of such use of a tree structure is described below with reference to FIG. 7.

In some implementations, not all of the received image identifiers are ranked. For example, some of the image identifiers may have been removed in block 608 as referencing images that are too visually similar to other identified images. In some implementations, only a predetermined number of the image identifiers obtained from block 608 are ranked.

The ranking order resulting from method 600 can be used in a variety of applications. One use is in the hierarchical data structure described herein, where one or more of the highest ranked image identifiers are stored in a group of selected image identifiers for a particular time period at a particular time scale in the hierarchical data structure. The highest ranking image identifiers can be picked for the group. In some implementations, a predetermined number of ranked image identifiers are provided in the group. Thus, the selected image identifiers in a group identify images that have been selected out of a set of images based on their image characteristic score and their time diversity over a relevant time period.

In some implementations, the group of image identifiers and ranked order can be provided to a requesting process or device (e.g., the server storing the hierarchical data structure, a remote client device, etc.) that has requested the ranking order of the images identified by the image identifiers.

FIG. 7 is a diagrammatic illustration of one example of a tree structure 700 that can be used to determine a ranking order of a plurality of images and image identifiers. In this example, tree structure 700 is a binary tree, but can be other types of trees in other implementations. In some implementations, an image identifier with the highest image characteristic score uses one or more connected branches in the binary tree structure to be positioned highest in the binary tree, and each successive image identifier in the ranking order is selected from an unused branch of the binary tree and has the highest image characteristic score among the image identifiers in the unused branch.

A plurality of image identifiers 1-8 have been provided for use with the tree structure 700 in the example of FIG. 7. Each image ID refers to a particular associated image. These image IDs are provided in a time order and refer to images that have a time value in this same order. The image identifiers 1-8 are placed in the bottom leaf nodes of the tree structure 700. An image characteristic score can be used to determine which of the image IDs should be moved to the top of the tree. For example, the image characteristic score can be a combination score measuring multiple characteristics of an image, as described above with reference to FIG. 6.

In some implementations, initially, the image ID for the image having the best (e.g., highest) score can be moved up its connected path to the top of the tree, and each branch path taken by that image ID can be marked as used. In the example of FIG. 7, the image ID 7 is found to have the highest image characteristic score, and so it is moved to the top of the tree via its branch paths 702, 704 and 706 which are marked as used. The image ID 7 is given the highest rank in the ranking order.

The next, successive image ID in the ranking order is then determined. This next ID can be the highest scoring image ID that is in a different branch of the tree than the ID that was just ranked. In one example, the different branch of the tree can be determined by following one or more unused branch paths of the tree and finding an unoccupied node as high in the tree as possible. For example, the next ranked ID after the first ranked ID can be connected to the other half of the tree relative to the half of the tree holding the first-ranked ID. Unused branch paths follow the other half of the tree from the top node, and the highest unoccupied node is at the level just under the top node. The highest scoring ID from that other half of the tree can be selected as the next ranked ID.

In the example of FIG. 7, since ID 7 was just ranked as the top ranking ID and is positioned in the right half of the tree 700, the next ID can be selected from the left half of the tree where an unused branch from the top node exists. It is found that the highest scoring ID from the left half of the tree is ID 2 (e.g., comparing the scores of IDs 1-4 in that branch), and so ID 2 is moved up the tree as far as possible and the branch paths 708 and 710 followed by ID 2 are marked as used.

By picking a different branch of the tree, the method selects an image ID that is more likely to have a greater time interval between the selected image ID and the image ID that was just ranked. For example, this may provide greater time diversity in the order of ranked images than if the image IDs were ranked only on image characteristic scores.

In a different implementation, the next ID can be connected to a different second-level node 712 than the ID that was just ranked. For example, since ID 7 was just ranked, the next ID selected can be the highest scoring ID from the remaining IDs at the other leaf nodes except ID 8, which is connected to the same second level node as ID 7.

To continue the example after ID 2 is selected for the second rank, a third ranked ID can be determined by looking for the highest unused paths and unoccupied nodes. For example, paths 716 and 718 are the highest unused branch paths and unoccupied nodes are located at the bottom ends of those paths after ID 2 was chosen for the second rank. In some implementations, all the IDs connected below those unused paths can be assembled and the ID is selected from those assembled IDs that has the highest image characteristic score. For example, it may have been found that image ID 3 has the highest score from the assembled IDs 3-6, and so ID 3 is assigned the third rank and is moved up branch 720 to the unoccupied node, and the branches 716 and 720 are marked as used. In other implementations, the third ranked ID is selected by picking one of the unused paths 716 and 718 (e.g., randomly) and selecting the highest scoring ID from the unranked IDs in that single branch. In this example, if the path 716 was randomly selected, the highest scoring ID would be selected from IDs 3 and 4.

If a fourth ranked ID is to be determined, then the highest unused paths and unoccupied nodes are again examined. In this case, path 718 is still unused, and so to ensure time diversity from the other IDs that have been ranked, the highest scoring ID from the IDs 5 and 6 in that branch is selected as the fourth ranked ID. In this example, the highest scoring ID is 5 which is moved up branch 722, and branches 722 and 718 are marked as used.

Additional ranked IDs can be selected by providing time diversity. For example, the remaining unused branches after the fourth ranked ID are at the lowest branch level, and the remaining IDs are all positioned in different branches (e.g., are connected to different second level nodes). These remaining IDs can be assembled together and ranked based on their image characteristic scores. For example, the highest image characteristic scores are found to be, in descending order, IDs 8, 1, 4, and 6, and so these IDs are assigned ranks 5, 6, 7, and 8, respectively.

The image IDs can be provided as output in their resulting ranked order. In some implementations, the finalized ranking list can be stored and/or provided to a requesting process or device. For example, the image IDs with their respective ranks can be provided to the hierarchical data structure described above for storage as a group for a particular time period in the structure.

The tree structure described herein can also be adaptive to select different numbers of highest ranked images as requested by processes or devices, and can efficiently ensure that any requested number of highest ranked images includes time diversity. For example, a method can pre-process a set of images to store the 50 highest ranked images as determined using the tree structure for a particular time period. At a later time, a client device requests 28 highest ranked images for that time period. The original set of images can be processed anew using the tree structure to determine 28 highest ranked images, where these 28 images have been ranked to include time diversity. If, instead, the top 28 images had been selected as the highest 28 images of the 50 highest ranked images, then these images would likely not have been as time diverse. A random selection of 28 images over the 50 images could be performed to create more time diversity, but would not likely provide as time-diverse images as use of the tree structure.

In some implementations, in addition or alternatively to including time diverse images in the groups of selected images as described above, described methods can include images in each of these groups based on or ensuring other types of diversity. For example, the images in a group can have image content diversity (e.g., not all the images in the group depict faces, not all the images depict a particular type of object (e.g., a car), and/or not all the images depict other types of content), color diversity (e.g., not all the images depict the same blue color range detected for ocean scenes), time of day diversity (e.g., not all the images have timestamps within a time range indicating the afternoon), etc.

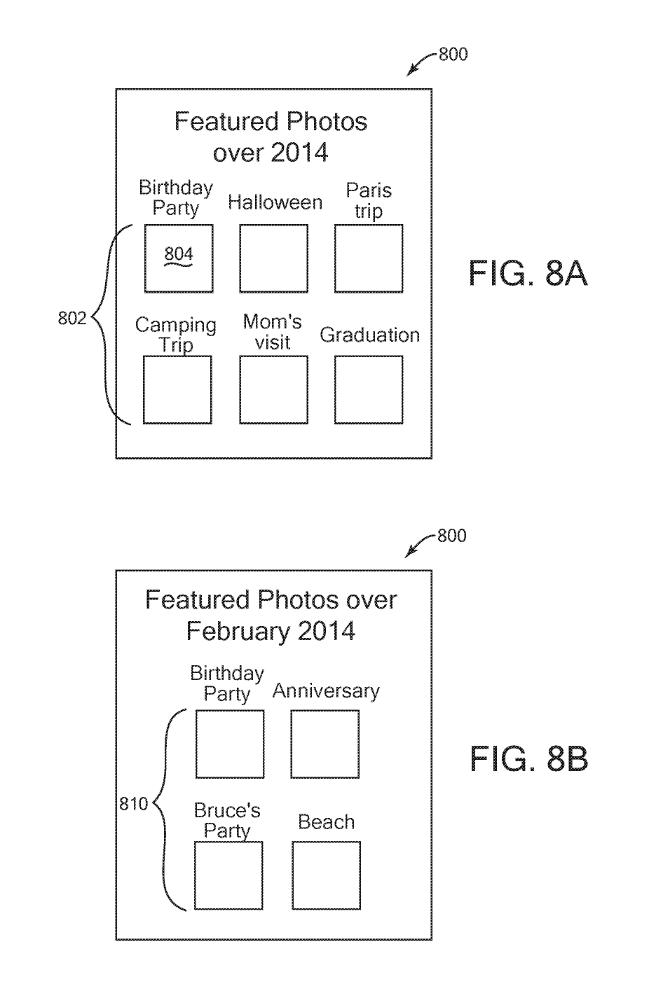

FIGS. 8A and 8B are diagrammatic illustrations of an example user interface 800 displayed on a display of a device and illustrating one or more features described herein. In some implementations, an application program running on a client device can provide the user interface 800 and can display images based on device events, a user's commands and preferences, and/or other input.

FIG. 8A shows user interface 800 displaying selected images obtained from a user's collection of images. In this example, the user has commanded the device to display selected images over the last occurring calendar year, e.g., 2014. In response, the client device requests a hierarchical data structure (e.g., similar to hierarchical data structure 500 of FIG. 5) to provide image identifiers of the six highest ranked images over the entire year 2014. In some examples, the number of selected images (six in this example) can be a default amount for the client device at any time scale (year, month, etc.), can be a user-specified or preferred amount, or can be an amount specifically associated with the specified time scale. If the hierarchical data structure is provided on a server or other remote device, the client can send this request over a network to the server. In other cases or implementations, the client device may have the hierarchical data structure (or a portion thereof) resident in its own memory or other storage for reference.

The hierarchical data structure is examined at the requested year level and the time period of 2014 is located. A number of image identifiers are obtained from the group of selected image identifiers of that time period. In this example, six image identifiers are requested by the client device. In some implementations, the six highest ranking image identifiers of the selected images are determined on the fly (after the request) using the hierarchical data structure and using a structure such as the tree structure described with reference to FIG. 7. In other implementations, the group of selected images was pre-processed at an earlier time and the six highest ranking image identifiers can be retrieved from storage. If the server stores the hierarchical data structure, the server can provide the six identifiers to the client device. In some implementations, all ranked image identifiers from the selected image identifiers are provided, allowing the client or application program to select the desired number of highest ranking image identifiers (six, in this example) from a larger list of ranked image identifiers.

The client device retrieves the images referenced by the six image identifiers and displays them as images 802 in the user interface. In some implementations, the client device requests the image data of these images from a remote device such as a server. In some implementations, the client device displays the six images based on their timestamps rather than based on their ranking order as provided in the group of selected images. For example, the client device can display the images in reverse chronological order, e.g., latest image first. Other implementations can display the images based on their ranked order.

In some implementations, an event label can be assigned to each displayed image based on the event set from which the displayed image was selected. Some examples of event labels are shown in FIG. 8A.

In some implementations, the user can select any one of the displayed images to drill down to a lower (more granular) time scale. For example, the selection of an image such as image 804 can cause the interface to drill down to a lower time scale and show images in a time period in which the selected image is a member. An example is shown in FIG. 8B.

In some implementations, the user can otherwise command the device to display additional details related to a selected image. For example, image 804 can be selected by the user to cause a display of a number of images that have been organized into the same event set as the selected image 804 in the hierarchical data structure. In one example, the client device requests a predetermined number of images from the event set designated by the selected image. The predetermined number of image identifiers are retrieved from a group of selected image identifiers in hierarchical data structure for the designated image, and the images referenced by those image identifiers are displayed by the client device for the user, e.g., in an order based on their timestamps.

In FIG. 8B, the user interface 800 has been commanded by the user to display the next lower time scale below the displayed year time scale displayed in the user interface in FIG. 8A. In an example hierarchical data structure, the next lower time scale is a month time scale. For example, selecting image 804 can be considered a command to cause the user interface to display a predetermined number of selected images from the month in 2014 in which the selected image 804 was included. In this example, the client device requests four images 810 which are the four highest ranking images from the group associated with the month of February 2014 in the hierarchical data structure. The images 810 can be displayed based on their timestamps, for example, or based on their ranked order.

In some implementations, if the client device needs to display additional or less images than are currently displayed, the client device can determine which of the images from that time period to display using the ranked order. For example, if the client device is provided the list of ranked image identifiers, the client device can select any desired number of identifiers from the top of the list and display those images. In some examples, a display screen can be in portrait orientation and the client device takes the top four ranked images from the list and displays them as four images in chronological order that fit on the screen. If the display screen is changed to a landscape orientation, the client device can display additional images, and so takes the top six ranked images from the list and displays them in chronological order, without having to re-process the original images to determine the six top ranked images. In some implementations, the client device can use a ranking data structure as described in FIG. 6 (e.g., a tree structure similar to that of FIG. 7) with a group of selected images to determine the six highest ranked images and provide time diversity for the six images, if the ranked list has not already been determined to include six or more images.

FIG. 9 is a flow diagram illustrating an example method 900 to notify and display past images for a user. Method 900 can be implemented on a client device, server device, or both client and server devices, e.g., portions of the method performed on client devices and other portions performed on server devices, with appropriate communication of data between these devices. In some implementations, method 900 can make use of a hierarchical data structure and/or ranked images described above to determine interesting images for the user at desired time periods and time scales.

In block 902, it is checked whether user consent (e.g., user permission) has been obtained to use user data in the implementation of method 900. Examples of user data are described throughout this description. One or more blocks of the method 900 may use such user data in some implementations. If user consent has been obtained from the relevant users for which user data may be used in the method 900, then in block 904, it is determined that the blocks of the method 900 can be implemented with possible use of user data as described for those blocks, and the method continues to block 906. If user consent has not been obtained, it is determined in block 905 that blocks are to be implemented without use of user data, and the method continues to block 906. In some implementations, if user consent has not been obtained, the remainder of method 900 is not performed.

In block 906, a notification date (and or time) is determined on which to send a notification to a user. In some implementations, the notification date can be every day, such that the notification date is the next day that has not yet been examined for notification. Other implementations can determine one or more particular days to notify, e.g., holidays, birthdays (of the user and friends), anniversaries, weekend days, vacation days, etc. Notification dates can be days known to be of importance or significance to the user. Important days can be determined, for example, based on user data such as user preferences, calendar data, activity data, etc. (which can be obtained if consent has been obtained from the user as described above). For example, a calendar event that matches an event on a list of predetermined events can be considered important, e.g., an event labeled as “wedding,” “birthday,” etc. The time of notification on the notification date can be a predetermined time. For example, if the notification date is every day, the notification time can be the same time on every day, e.g., at 9:00 AM. Other implementations can vary the time of notification on notification dates.

In some implementations, a notification date and/or time can be determined based on other factors. For example, if it is detected that a user has traveled to a particular geographical location (e.g., based on GPS sensor data provided by a device worn or carried by the user), it can be determined that a potential notification date is the current day and time, if one or more significant events and images related to that location can be found (e.g., in the user's collection of images), as described below. Similarly, user activities and other real-time events (e.g., detected by a device on the person of the user) can be examined to determine whether to set a notification date to the current time.

In block 908, sets of images are examined in event sets occurring on past dates relative to the notification date. The sets of images can be associated with the user, e.g., a user's collection of images, and/or images accessible by the user. In some implementations past dates can be examined that are predetermined time intervals in the past relative to the notification date. For example, past dates that are multiples of 1-year intervals relative to the notification date can be examined, such as dates 1 year, 2 years, 3 years, etc. before the notification date. In other examples, past months, weeks, days, or other time intervals can be used.

The examined images can be provided in event sets. For example, some implementations can use event sets of image identifications defined in a hierarchical data structure, as described herein. Each event set includes a number of images determined to have occurred (e.g., captured or otherwise timestamped) within a particular event. In some implementations, event sets can be defined and separated by time intervals between images in the event sets and/or other image characteristics, as described for event sets above. In some implementations, the examined images can be a group of selected images determined from the images in the event set, as described above.

In block 910, one or more event sets are determined as qualifying for notification based on image characteristics. For example, characteristics in the examined images of block 908 can be examined to determine if such characteristics qualify the event for notification. In some implementations, a system can check for characteristics that indicate that the event represented by the event set is a memorable one for the user and/or significant enough to the user that the user may want to be reminded of the event. In some examples, a plurality of different relevant factors can be examined to determine a combined overall score for an event set that indicates whether the event set qualifies for notification. For example, a combined score satisfying a predetermined threshold can qualify the event set for notification. Each factor (e.g., characteristic) can provide its own contribution to the overall score, and each can be weighted based on its type, based on particular user preferences, etc. Some examples of such factors are now described.

In some implementations, the number of images in an event set can be examined to determine whether the event set qualifies for notification. For example, the greater the number of images in the event set, the more significant it can be considered. In some implementations, if the number of images in the event set is lower than a predetermined threshold, the event set cannot be qualified for notification. Some implementations can examine the number of image identifiers in the group of selected image identifiers for each event set as described above, rather than examining the entire event set time periods.

Some implementations can examine a factor such as a distribution of images within an event set across the time period represented by the event set, to determine whether that event set qualifies for notification. For example, this can be a time distribution, where the time intervals between images in the event set can be examined. In some implementations, qualification can be penalized for an event set that has one or more time intervals between the images of the event set that are below a threshold time interval. In one example, such small time intervals can indicate that the associated images were captured very close in time to each other, such as images captured in a burst mode of a camera. Such small time intervals may not necessarily indicate a significant event for the user despite having a large number of images. The images that have time values so close together can be considered less significant than images having time values further apart within the event set. For example, an image captured every 1 or 2 minutes over a particular time period may indicate a continued interest from the user in the event, and this can be an event of more significance to the user than a single burst of a larger number of images captured every 2 seconds.

In another example, the distribution of the images within the event set can include an estimated time coverage of the images over the time period of the event set. If the estimated time coverage is under a predetermined threshold timespan, the event set can be disqualified for notification or reduced in its weight or score for qualification. In some implementations, the weight of the time coverage factor for qualification can be proportional to the amount of time covered by the images in the event set. In one example, each image can be considered to span a predetermined length of time, such as four minutes: 2 minutes before the time value of the image and 2 minutes after. Successive images that are captured closer in time than 2 minutes have their spans overlap to some degree, reducing the spans. The reduced overlapped spans contribute less overall time to the total time coverage over the time period of the event set as compared to images that have time intervals of two or more minutes.

Some implementations can examine image content factors to determine whether the event qualifies for notification. In some implementations, predetermined types of image content can be sought in the images which is considered to indicate significance to the particular user and/or to general users. For example, significant events can include wedding anniversaries, birthdays, vacations, holidays, significant business events, meeting people, parties with lots of persons present, visiting famous places, or other events of personal significance to the user. In some examples, particular faces, landmarks, objects, and other features can be searched for depiction in images using recognition techniques (if user consent has been obtained), those features being considered important to general users or to the specific user associated with the images. For example, faces can recognized (with user consent) using facial recognition techniques, and landmarks can be recognized using landmark recognition techniques (e.g., comparing shapes in images to model patterns or shapes). In some implementations, the identity of faces need not be determined. If identity is determined (e.g., to determine if a family event is depicted), identity may be determined if user consent from the depicted user has been obtained. Some examples of particular objects that may be of significance include birthday cakes, handshakes, holiday decorations or other decorations (e.g., Halloween jack-o-lanterns, etc.), wedding decorations, dances, a larger number of persons depicted (e.g., over a threshold number), a particular type of clothes (e.g., formal dress), etc. Location data (e.g., metadata of images) can be used to help recognize particular features such as landmarks, parks, restaurants, etc. (if user consent has been obtained). User data (e.g., user preferences, health data, calendar data, activity data as described above) can also be used (if user consent has been obtained) to help recognize features in images as factors to help determine which features depicted in an image have significance to the user. Event labels stored or otherwise associated with an event set can also be examined, as descriptions of event sets determined as described above.

Some implementations can check for patterns that may be found within images across multiple event sets examined in block 908 that can influence event set qualification (and/or check for patterns in images occurring at other time intervals relative to the notification date). In some examples, if particular (or similar) image characteristics such as particular recognized content, geographic location, visual characteristics, user data, or other image characteristics occurred over multiple event sets (e.g., in every event set examined for successive time periods such as successive years), then these particular characteristics may be considered more significant to the user due to their repeating nature. The event sets that have these images can be weighted higher for qualification. This can allow a system to learn of user preferences and habits that have occurred over time, and to select event sets that are more significant to the user.

In block 912, one or more representative images are determined from the qualifying event sets. For example, the representative images can be images determined to be of high enough importance and/or high enough scoring in image characteristics (e.g., to indicate visual quality) to be displayed in the notification. In some implementations, an image in a qualifying event set can qualify to be included in the notification if it has an individual score greater than a predetermined individual threshold. In some implementations, the individual score can be determined based on image content factors similarly as described above to qualify for notification, e.g., recognition of faces, landmarks, objects, etc., use of location data, user data, etc. In some implementations, a predetermined number of the highest scoring representative images are designated to be images initially displayed in the notification and the first images to be seen by a user.

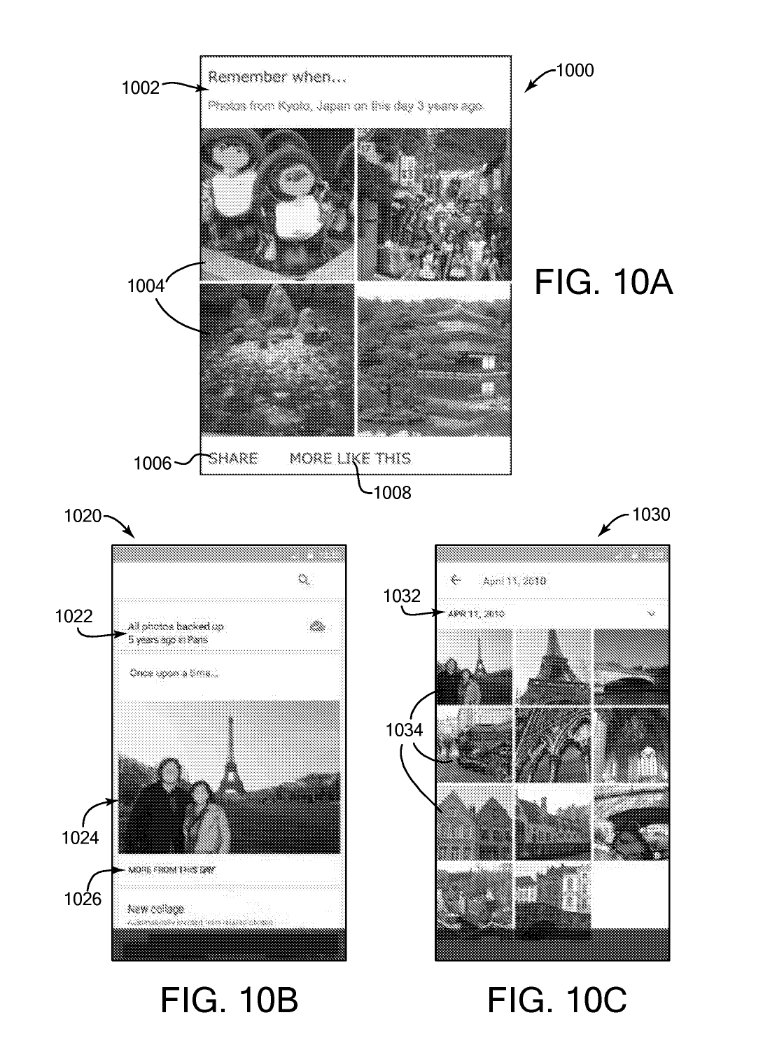

In block 914, a notification is caused to be sent to the user on the notification date. The notification indicates one or more selected images from event sets that were determined to be qualified in block 910. For example, the notification can display the representative images determined from each qualifying event set. In some implementations, the notification can display a predetermined number of representative images in total, such that the highest scoring images within the predetermined number limit are displayed in the notification. In some implementations, a small number of the highest scoring representative images are displayed, and an option is displayed in the notification to display additional images from each qualifying event set, if desired. In some implementations, these additional images can be representative images determined in block 912. Some examples of notifications and options for the user are described below with reference to FIGS. 10A-10C. In some implementations, if no qualifying event sets were found for the notification date, then no notification is caused to be sent in block 912.

In some implementations, the notification can be scheduled to be sent to the user, where the scheduling is performed before the notification is sent. For example, the notification can be scheduled to be sent within a predetermined time period of the notification time. In some implementations, a large number of notifications are to be sent to a large number of users at about the same time, and the notification can be provided to a task scheduler that can schedule the task for delivery to the user's client device. In some implementations, a current time zone of the user can be determined and used to determine the actual time to send the notification. For example, the user's current time zone can be determined by examining metadata (e.g., timestamp) information in one or more recent images captured and provided by one or more devices of the user. For example, the examined recent images can be required to have been captured within a predetermined time threshold of the time of notification, to be used in determining the user's current time zone.

FIGS. 10A-10C are diagrammatic illustrations of example notifications and other features allowing a user to view images based on notifications received by the user.

FIG. 10A shows an example of a notification 1000 that has been received by a client device of a user and displayed on a display of the client device. In this example, notification 1000 includes an information caption 1002 indicating that the images displayed by the notification are from the past of the user. The caption 1002 also indicates a geographical location at which the images were captured (or are otherwise associated with), and one or more dates on which the images were captured (or are otherwise associated with). In this example, a date associated with the images is expressed as the amount of time in the past relative to the current time, e.g., 3 years ago.

One or more representative images 1004 are displayed in the notification 1000. These are images that are associated with particular time periods of the past and which have been determined to be important or significant to the user. In this example, the particular time periods examined include days in the past that occurred on the same date as the current date in yearly intervals relative to the current day, such as days occurring 1 year ago, 2 years ago 3 years ago, and so on. In some examples, the examined dates can have a predetermined limit or pattern, e.g., only dates going back a maximum of 10 years from the current date, dates occurring in 5 year intervals, etc.

In this example, the representative images 1004 are included in an event set of images that has been qualified for notification as described in FIG. 9. The event set was qualified by scoring sufficiently highly to be considered important to the user to be included in the notification. Other event sets of images may also exist on one or more of the examined past days, but these event sets did not score sufficiently to qualify for notification, and so were excluded from the notification. In some implementations, images from other non-qualifying events occurring on the same day (or other time period) as the representative images can be accessible for viewing from one or more options displayed in the notification 1000 (not shown).

The notification 1000 can be an initial display of the notification that is first seen by the user (e.g., the first full-sized display of the notification). In such an initial view, the notification can display a selected set of representative images from the qualifying event. For example, the images 1004 can be images that have scored the best relative to other images in the event to be displayed in the initial view of the notification. These images may have been found to be the highest scoring for particular image characteristics (e.g., particular significant image content such as faces, landmarks, or particular objects). These images 1004 are also selected to be different from each other, since the user is not likely to want to see images too similar to each other. For example, the images 1004 can be selected from different qualifying events (if possible), can be separated in time by a threshold amount or by using a ranking structure such as the tree of FIG. 7, etc. In this example, the images 1004 depict features that the notification method considered to be important to users, including landmarks, number of persons, and sufficient separation in time.

The notification 1000 includes a display of one or more options receptive to user input, including a share option 1006 and an additional images option 1008. For example, if the share option 1006 is selected by a user, the displaying device can present a sharing interface allowing the user to select particular users (or user-associated devices) to receive the images 1004, e.g., over a connected communication network. If the additional images option 1008 is selected, the device can display additional images that were included in the same event set as the images 1004, or from the same day (or other designated time period). One example is shown with respect to FIG. 10C.

FIG. 10B shows another example of a notification 1020 that has been received by a client device of a user and displayed on a display of the client device. This can be an initial display of the notification similar to notification 1000 of FIG. 10A. Notification 1020 can provide similar information and options as described above for FIG. 10A. For example, one or more time periods and geographic locations relevant to the images displayed in the notification can be displayed in a caption 1022.

A representative image 1024 is displayed in this initial display of the notification as the highest scoring image selected from the event sets of images that qualified for notification on this date. In this example, one representative image is displayed from one qualifying event set. Some implementations can display a predetermined number of images as the representative images. Some implementations can display a predetermined number of images from each qualifying event set. In some implementations, a preferences settings or menu can be provided allowing user input to select preferences indicating the number of representative images that the user would like to be displayed in the initial display of notifications. For example, the user can select to display a total number of representative images, and a number of representative images per event set.

In some implementations, the representative image 1024 can receive a selection from the user (e.g., via touchscreen input, control of a pointer/cursor via an input device, etc.), and the device displays an editing interface allowing the user to provide user input to edit the representative image. For example, pixel characteristics (hue, brightness, etc.) can be edited, the image can be rotated, cropped, etc.

An additional images option 1026 can also be displayed in the notification 1000. If this option is selected by the user, the device can display additional images from the same event set as the image 1024, as described below.

FIG. 10C shows an example user interface 1030 displayed on a display screen in response to the user selecting the additional images option 1026 displayed in notification 1020 of FIG. 10B. In some implementations, the user interface 1030 can be considered as an additional or extension display included in the notification 1020.

User interface 1030 can display a date 1032 indicating the time period relating to the additional displayed images. User interface 1030 also displays a number of additional images 1034. These are images included in the same event set of images from which the initially-displayed image 1024 was selected. In some implementations, a predetermined number of additional images from the event set are displayed in interface 1030, such as a predetermined number of highest scoring images, and/or highest ranked images from the event set using the techniques for determining a group of selected images and ranking of images described herein. In some implementations, additional or all images included in the same event set as the image 1024 can be displayed in response to user input selecting a displayed option to do so. In some implementations, additional displayed images from the event set are displayed as the user scrolls the images, e.g., the user input can scroll the images 1034 vertically or horizontally (e.g., with reference to interface or display screen borders) to move one or more images off the screen and display additional images on the screen.

In some implementations, each of the additional images 1034 can receive user input selecting that image. If selected, the device can display the selected image as a larger image in a higher resolution. In some implementations, additional images 1034 can be displayed as lower-resolution thumbnails which can be displayed in a larger pixel resolution if selected by user input.

In some implementations, if multiple event sets of images occurred on the examined time periods and multiple of these event sets were determined to have qualified for the notification 1020, then the images from these different event sets can be displayed to be visually and functionally distinguished in user interface 1030 and/or in notification 1020. For example, if an event set of images on Apr. 11, 2010 as well as an event set of images on Apr. 11, 2012 qualify for the notification 1020, then each of these event sets can be provided with its own caption 1032 and its associated images displayed next to the caption. The associated images can be only partially displayed, allowing multiple event set captions 1032 to be displayed on a single screen (e.g., without scrolling or providing additional screens).

In some implementations, methods described herein can be implemented, for example, on a server system 102 as shown in FIG. 1. In some implementations, some or all of the methods can be implemented on a system such as one or more client devices 120, 122, 124, or 126 as shown in FIG. 1, and/or on both a server system and a client system. In some implementations, different components of one or more servers and/or clients can perform different blocks or other parts of the methods.

Methods described herein can be implemented by computer program instructions or code, which can be executed on a computer. For example, the code can be implemented by one or more digital processors (e.g., microprocessors or other processing circuitry) and can be stored on a computer program product including a non-transitory computer readable medium (e.g., storage medium), such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

It should be noted that the blocks described in the methods disclosed herein can be performed in a different order than shown and/or simultaneously (partially or completely) with other blocks, where appropriate. Not all of the described blocks need be performed in various implementations. In some implementations, blocks can be performed multiple times, in a different order, and/or at different times in the methods. In some implementations, the methods can be implemented, for example, on a server system 102 as shown in FIG. 1. In some implementations, one or more client devices can perform one or more blocks instead of or in addition to a server system performing those blocks.

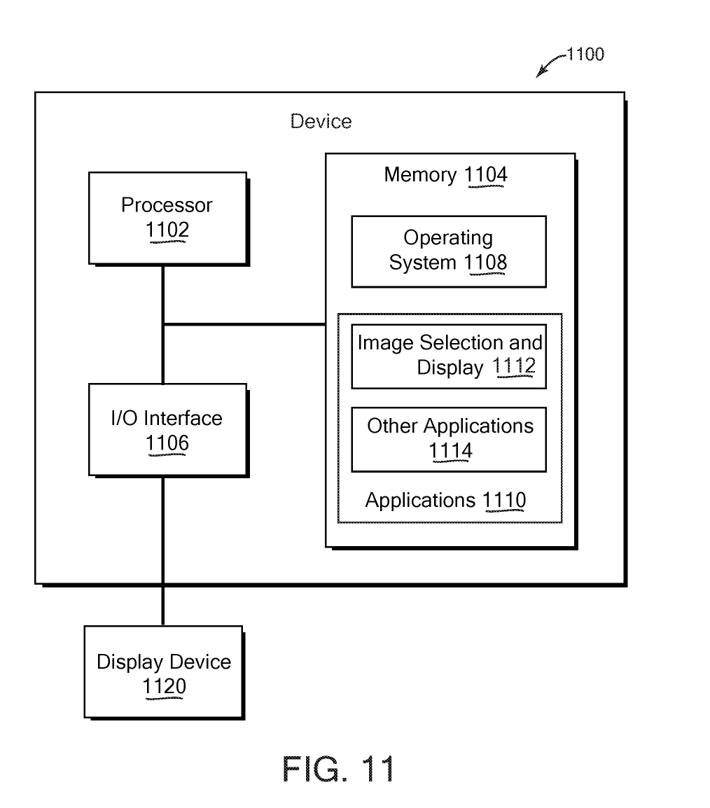

FIG. 11 is a block diagram of an example device 1100 which may be used to implement some implementations described herein. In one example, device 1100 may be used to implement a computer device that implements a server device, e.g., server device 104 of FIG. 1, and perform appropriate method implementations described herein. Device 1100 can be any suitable computer system, server, or other electronic or hardware device. For example, the device 1100 can be a mainframe computer, desktop computer, workstation, portable computer, or electronic device (portable device, cell phone, smart phone, tablet computer, television, TV set top box, personal digital assistant (PDA), media player, game device, wearable device, remote control, handheld game- or device-controller, etc.). In some implementations, device 1100 includes a processor 1102, a memory 1104, and input/output (I/O) interface 1106.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Processor 1102 can be one or more processors and/or processing circuits to execute program code and control basic operations of the device 1100. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1104 is typically provided in device 1100 for access by the processor 1102, and may be any suitable processor-readable storage medium, such as random access memory (RAM), read-only memory (ROM), Electrical Erasable Read-only Memory (EEPROM), Flash memory, etc., suitable for storing instructions for execution by the processor, and located separate from processor 1102 and/or integrated therewith. Memory 1104 can store software operating on the server device 1100 by the processor 1102, including an operating system 1108 and one or more applications 1110 such as a graphics editing engine, web hosting engine, image display engine, notification engine, social networking engine, etc. In some implementations, the applications engines 1110 can include instructions that enable processor 1102 to perform functions described herein, e.g., some or all of the methods of FIGS. 2, 3, 4, 6, and 9. For example, applications 1110 can include one or more image selection and display applications 1112, including a program to receive user input, request images from specified time periods and time scales, select images, and provide output data causing display of original and modified images on a display device of the device 1100. An image display program, for example, can provide a displayed user interface responsive to user input to display selectable options/controls and images based on selected options. Other applications or engines 1114 can also or alternatively be included in applications 1110, e.g., image editing applications, media display applications, communication applications, web hosting engine or application, etc. One or more methods disclosed herein can operate in several environments and platforms, e.g., as a standalone computer program that can run on any type of computing device, as a web application having web pages, as a mobile application (“app”) run on a mobile computing device, etc.

Any of software in memory 1104 can alternatively be stored on any other suitable storage location or computer-readable medium. In addition, memory 1104 (and/or other connected storage device(s)) can store images, image identifiers, data structures, metadata for images (timestamps, location data, labels, user data, etc.), image recognition data, patterns, and other information, user preferences, and/or other instructions and data used in the features described herein. Memory 1104 and any other type of storage (magnetic disk, optical disk, magnetic tape, or other tangible media) can be considered “storage” or “storage devices.”

I/O interface 1106 can provide functions to enable interfacing the server device 1100 with other systems and devices. For example, network communication devices, storage devices (e.g., memory and/or database 106), and input/output devices can communicate via interface 1106. In some implementations, the I/O interface can connect to interface devices such as input devices (keyboard, pointing device, touchscreen, microphone, camera, scanner, etc.) and/or output devices (display device, speaker devices, printer, motor, etc.). Display device 1120 is one example of an output device that can be used to display content, e.g., one or more images provided in an image editing interface or other output application as described herein. Display device 1120 can be connected to device 1100 via local connections (e.g., display bus) and/or via networked connections and can be any suitable display device, some examples of which are described below.

For ease of illustration, FIG. 11 shows one block for each of processor 1102, memory 1104, I/O interface 1106, and software blocks 1108 and 1110. These blocks may represent one or more processors or processing circuitries, operating systems, memories, I/O interfaces, applications, and/or software modules. In other implementations, server device 1100 may not have all of the components shown and/or may have other elements including other types of elements instead of, or in addition to, those shown herein. While system 102 is described as performing blocks and operations as described in some implementations herein, any suitable component or combination of components of system 102 or similar system, or any suitable processor or processors associated with such a system, may perform the blocks and operations described.

A client device can also implement and/or be used with one or more features described herein, e.g., client devices 120-126 shown in FIG. 1. Example client devices can include some similar components as the device 1100, such as processor(s) 1102, memory 1104, and I/O interface 1106. An operating system, software and applications suitable for the client device can be provided in memory and used by the processor, e.g., image selection and display software, client group communication application software, etc. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device 1120, for example, can be connected to or included in device 1100 to display images as described herein, where such device can include any suitable display device such as an LCD, LED, or plasma display screen, CRT, television, monitor, touchscreen, 3-D display screen, or other visual display device. Some implementations can provide an audio output device, such as voice output or synthesis that speaks text.

Although the description has been described with respect to particular implementations thereof, these particular implementations are merely illustrative, and not restrictive. Concepts illustrated in the examples may be applied to other examples and implementations.

The systems and methods discussed herein do not require collection or usage of user personal information. In situations in which certain implementations discussed herein may collect or use personal information about users (e.g., user data, information about a user's social network, user's location, user's biometric information, user's activities and demographic information), users are provided with one or more opportunities to control whether the personal information is collected, whether the personal information is stored, whether the personal information is used, and how the information is collected about the user, stored and used. That is, the systems and methods discussed herein collect, store and/or use user personal information only upon receiving explicit authorization from the relevant users to do so. In addition, certain data may be treated in one or more ways before it is stored or used so that personally identifiable information is removed. As one example, a user's identity may be treated so that no personally identifiable information can be determined. As another example, a user's geographic location may be generalized to a larger region so that the user's particular location cannot be determined.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed such as procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
receiving a request from a device for one or more images, wherein the request specifies one or more specified time periods at each of one or more specified time scales;
determining one or more groups of selected images from a set of images, each group being within one of the one or more specified time periods at one of the one or more specified time scales; and
causing one or more of the selected images from the one or more groups to be sent to the device.

2. The method of claim 1 wherein the one or more specified time scales are referenced in a stored hierarchical data structure storing a different time scale of images at each hierarchical level of the hierarchical data structure, wherein the different time scales of images are used for determining the one or more groups of selected images within the one or more specified time periods at the one or more specified time scales.

3. The method of claim 1 wherein the groups of selected images are organized in particular time periods defined in the hierarchical data structure based on time data associated with the images.

4. The method of claim 1 wherein the one or more specified time scales include at least one of: an event level time scale, a day level time scale, a week level time scale, a month level time scale, a year level time scale, and a decade level time scale.

5. The method of claim 1 wherein determining one or more groups of selected images includes examining the set of images and determining rankings of images in particular time periods based on image characteristics of the set of images, wherein the group of selected images is determined from highest ranking images of the images in particular time periods.

6. The method of claim 5 wherein each image is associated with a time value, and wherein determining rankings is based on the image characteristics and is based on providing a time diversity for the time values of successively-ranked images.

7. The method of claim 1 wherein causing the one or more selected images to be sent includes sending one or more image identifiers that identify the one or more selected images, and further comprising:
determining the one or more selected images to be sent to the requesting device based on one or more characteristics of the one or more selected images, wherein the one or more characteristics include at least one of:
a number of images included in the respective selected groups of the one or more selected images;
a time distribution of images included in the respective selected groups of the one or more selected images; and
a type of content depicted in the one or more selected images.

8. A non-transitory computer readable medium having stored thereon software instructions that, when executed by a processor, cause the processor to perform operations including:
receiving, at a client device from a server, image identification structured data including groups of selected image identifiers selected from one or more sets of image identifiers, wherein the groups of selected image identifiers are organized in a hierarchical data structure storing a different time scale of images at each hierarchical level of the hierarchical data structure;
examining the image identification structured data by the client device to obtain a number of selected image identifiers from one or more of the groups of selected image identifiers at a specified time scale;
requesting a number of images corresponding to the number of selected image identifiers from a server;
receiving the number of images from the server; and
displaying the number of images on a display of the client device.

9. The computer readable medium of claim 8 wherein the hierarchical data structure includes a plurality of defined time periods at each of the different time scales, and wherein the groups of selected image identifiers are provided in particular time periods defined in the hierarchical data structure based on time data associated with the images.

10. The computer readable medium of claim 8 wherein the selected image identifiers in the groups are determined based on one or more image characteristics of images corresponding to the one or more sets of image identifiers, wherein the selected image identifiers correspond to images having a particular ranking among images associated with time periods associated with the groups.

11. The computer readable medium of claim 8 wherein the selected image identifiers in each of the groups are associated with times that are diverse over time periods associated with the groups.

12. The computer readable medium of claim 8 wherein one or more of the selected image identifiers are included in multiple groups of selected images, wherein each of the multiple groups is provided at a different hierarchical level of the hierarchical data structure.

13. The computer readable medium of claim 8 wherein the operations further comprise:
requesting an update to the image identification structured data;
receiving updated image identification structured data; and
updating the groups of selected image identifiers in the hierarchical data structure.

14. A system comprising:
a storage device; and
at least one processor accessing the storage device and configured to perform operations comprising:
storing image identifiers for a set of images at a first hierarchical level of a data structure representing a first time scale and stored by the storage device;
determining a ranking order of a plurality of the image identifiers based on one or more characteristics of the images in the set of images corresponding to the plurality of image identifiers;
storing, at a second hierarchical level of the data structure, one or more highest ranking image identifiers in a group of selected image identifiers, wherein the second hierarchical level represents a second time scale at a higher time granularity; and
sending at least one image identifier of the group of selected image identifiers to a requesting device.

15. The system of claim 14 wherein the data structure includes a plurality of defined time periods at each of the hierarchical levels, and wherein the group of selected image identifiers is provided in a particular time period defined in the data structure based on time data associated with the images, wherein the defined time periods include at least one of:
a plurality of different event time periods at an event level of a hierarchical data structure;
a plurality of different day time periods at a day level of the hierarchical data structure;
a plurality of different week time periods at a week level of the level of the hierarchical data structure; and
a plurality of different month time periods at a month level of the hierarchical data structure.

16. The system of claim 14 wherein the at least one processor is further configured to perform operations comprising providing one or more additional hierarchical levels of the data structure, wherein each additional hierarchical level stores one or more groups of highest ranking image identifiers derived from one or more groups of highest ranking image identifiers at the next lower level of the data structure.

17. The system of claim 14 wherein the set of images is one of a plurality of sets of images, each set of images covering a different time period in a timeline, and wherein the processor is further configured to perform operations including repeating, for each of the sets of images at each different time period, the determining a ranking order and the storing one or more highest ranking image identifiers in a group of selected image identifiers.

18. The system of claim 14 wherein the operation of sending of the group of selected image identifiers includes sending the group of selected image identifiers to the requesting device at a synchronization time, and wherein the operations further comprise:
receiving one or more updates to the set of images;
determining an updated ranking order of the plurality of the image identifiers;
storing, at the second hierarchical level of the data structure, one or more highest ranking image identifiers in the group of selected image identifiers, wherein the group is based on the updated ranking order; and
sending one or more image identifiers from the updated group of selected image identifiers to the requesting device in response to receiving a second request from the device that indicates the synchronization time.

19. The system of claim 14 wherein the operation of determining a ranking order includes:
assigning the plurality of image identifiers to nodes in a ranking data structure, wherein the plurality of image identifiers are assigned in a time order based on a time associated with each image identifier, wherein each of the plurality of image identifiers is associated with an image characteristic score based on one or more characteristics of an image identified by the image identifier; and
determining a ranking order of the plurality of image identifiers based on the image characteristic scores and based on a time diversity of time values of the plurality of the image identifiers, wherein the ranking data structure is used to provide the time diversity for successively-ranked image identifiers.

20. The system of claim 19 wherein the ranking data structure is a binary tree structure, and the nodes are leaf nodes in the binary tree structure,
wherein assigning the plurality of image identifiers to nodes includes assigning one image identifier to a node from a similarity group of image identifiers determined to refer to visually similar images, and
wherein each successive image in the ranking order is selected from an unused branch of the binary tree and has the highest image characteristic score among the images in the unused branch.
